(19) United States
(12) Patent Application Publication
(10) Pub. No.: US 2022/0069336 A1
(43) Pub. Date: Mar. 3, 2022

(54) ELECTRODE STRUCTURE, SECONDARY BATTERY, BATTERY PACK, VEHICLE, AND STATIONARY POWER SUPPLY

(71) Applicant: KABUSHIKI KAISHA TOSHIBA, Tokyo (JP)

(72) Inventors: Hayato SEKI, Kawasaki Kanagawa (JP); Yasuyuki HOTTA, Tokyo (JP); Wataru UNO, Yokohama Kanagawa (JP); Shinsuke MATSUNO, Tokyo (JP)

(73) Assignee: KABUSHIKI KAISHA TOSHIBA, Tokyo (JP)

(21) Appl. No.: 17/180,685

(22) Filed: Feb. 19, 2021

(30) Foreign Application Priority Data
Aug. 27, 2020 (JP) 2020-143667

(51) Int. Cl. H01M 10/04; H01M 10/42

(52) U.S. Cl. CPC H01M 10/0468; H01M 2010/4271; H01M 10/425

(57) ABSTRACT

According to one embodiment, an electrode structure is provided. The electrode structure includes an electrode group and a hold member. The hold member clamps the electrode group in a thickness direction of the electrode group. The electrode group satisfies a formula (1) below.

m/L≤0.01 (1)

Here, m is a difference Δt in a cross section which is selected from among a plurality of cross sections along the thickness direction of the electrode group. L is a maximum length of the electrode group in an in-plane direction orthogonal to the thickness direction.

### CROSS-REFERENCE TO RELATED APPLICATIONS

This application is based upon and claims the benefit of priority from Japanese Patent Application No. 2020-143667, filed Aug. 27, 2020, the entire contents of which are incorporated herein by reference.

### FIELD

Embodiments described herein relate generally to an electrode structure, a secondary battery, a battery pack, vehicle, and a stationary power supply.

### BACKGROUND

A nonaqueous electrolyte battery, particularly, a lithium secondary battery using a carbon material or lithium titanium oxide as a negative electrode active material and a layered oxide containing nickel, cobalt, and manganese as positive electrode active materials has already been put into practical use as a power supply in a broad field. The form of such a nonaqueous electrolyte battery widely ranges from a small battery for various kinds of electronic devices to a large battery for an electric automobile. These lithium secondary batteries use, as the electrolytic solution, a nonaqueous organic solvent containing ethylene carbonate or methyl ethyl carbonate, unlike a nickel hydrogen battery or a lead storage battery. Electrolytic solutions using these solvents have high resistance to oxidation and high resistance to reduction as compared to an aqueous electrolyte solution, and electrolysis of the solvents hardly occurs. For this reason, a nonaqueous lithium secondary battery can implement a high electromotive force of 2 to 4.5 V.

On the other hand, since many organic solvents are combustible, the safety of a secondary battery using an organic solvent readily becomes lower than that of a secondary battery using an aqueous solution in principle. Although various measures are taken to improve the safety of a lithium secondary battery using an electrolytic solution containing an organic solvent, they are not necessarily enough. In addition, a nonaqueous lithium secondary battery requires a dry environment in its manufacturing process, and the manufacturing cost inevitably rises. Furthermore, since an electrolytic solution containing an organic solvent is poor in conductivity, the internal resistance of the nonaqueous lithium secondary battery readily becomes high. These problems are great disadvantages for a large storage battery used in an electronic automobile, a hybrid electronic automobile, or an electric power storage for which the battery safety and the battery cost are of importance.

A secondary battery using an aqueous electrolyte has been proposed to solve problems of a non-aqueous secondary battery. The secondary battery has, however, suffered from instability of operations since an active material can easily separate from a current collector, due to electrolysis of the aqueous electrolyte, leaving problems to be solved before charge-and-discharge can proceed at satisfactory levels. For satisfactory charge-and-discharge when using the aqueous electrolyte, it is necessary to limit a potential range, over which the battery is charged and discharged, within a potential range in which water contained as a solvent will not be electrolyzed. The aqueous solvent can be prevented from being electrolyzed, by using lithium manganese oxide as a positive electrode active material, and lithium vanadium oxide as a negative electrode active material. Such a combination might attain an electromotive force of 1 to 1.5 V or around, but is less likely to achieve an energy density enough for use as a battery.

Another possible combination may be lithium manganese oxide used as the positive electrode active material, and lithium titanium oxide such as LiTi₂O₄, Li₄Ti₅O₁₂ as the negative electrode active material, which can theoretically attain an electromotive force of 2.6 to 2.7 V or around, and can yield an attractive battery in terms of energy density. A non-aqueous lithium ion battery that employs such a combination of positive and negative electrode materials has succeeded in obtaining excellent life factor, and has already been put into practical use.

However in the aqueous electrolyte, insertion/extraction potential of lithium of the lithium titanium oxide occurs at a potential of approximately 1.5 V (vs. Li/Li⁺) relative to lithium potential, and this is likely to electrolyze the aqueous electrolyte. In particular, the negative electrode can vigorously produce hydrogen, due to electrolysis that occurs on the surface of the negative electrode current collector or a metal outer container electrically connected to the negative electrode, which could easily separate the active material from the current collector. Such a battery has therefore suffered from unstable operations, making the battery incapable of satisfying charge-and-discharge.

### BRIEF DESCRIPTION OF THE DRAWINGS

FIG. 1 is an exploded perspective view schematically illustrating an example of an electrode structure according to a first embodiment;

FIG. 2 is a cross-sectional view schematically illustrating a cross section of the electrode structure shown in FIG. 1, FIG. 2 being taken along a direction perpendicular or substantially perpendicular to a Y-axis direction of the electrode structure;

FIG. 3 is an exploded perspective view schematically illustrating another example of the electrode structure according to the first embodiment;

FIG. 4 is a cross-sectional view schematically illustrating a cross section of the electrode structure shown in FIG. 3, FIG. 4 being taken along a direction perpendicular or substantially perpendicular to the Y-axis direction of the electrode structure;

FIG. 5 is a cross-sectional view schematically illustrating another example of the electrode structure according to the first embodiment;

FIG. 6 is a cross-sectional view schematically illustrating an example of a secondary battery according to a second embodiment;

FIG. 7 is a cross-sectional view schematically illustrating a cross section of the secondary battery shown in FIG. 6, FIG. 7 being taken along a direction perpendicular or substantially perpendicular to an X-axis direction of the secondary battery;

FIG. 8 is a cross-sectional view schematically illustrating a cross section of the secondary battery shown in FIG. 6, FIG. 8 being taken along a direction perpendicular or substantially perpendicular to a Z-axis direction of the secondary battery;

FIG. 9 is a cross-sectional view schematically illustrating, in enlarged scale, a part of the secondary battery shown in FIG. 6;

FIG. 10 is a cross-sectional view schematically illustrating another example of the secondary battery according to the second embodiment;

FIG. 11 is a cross-sectional view schematically illustrating a cross section of the secondary battery shown in FIG. 10, FIG. 11 being taken along a direction perpendicular or substantially perpendicular to the Z-axis direction of the secondary battery;

FIG. 12 is an exploded perspective view schematically illustrating an example of a battery pack according to a third embodiment;

FIG. 13 is a block diagram illustrating an example of an electric circuit of the battery pack shown in FIG. 12;

FIG. 14 is a cross-sectional view schematically illustrating an example of a vehicle according to a fourth embodiment; and

FIG. 15 is a block diagram illustrating an example of a system including a stationary power supply according to a fifth embodiment.

### DETAILED DESCRIPTION

According to one embodiment, an electrode structure is provided. The electrode structure includes an electrode group and a hold member. The hold member clamps the electrode group in a thickness direction of the electrode group. The electrode group satisfies a formula (1) below.

m/L≤0.01 (1)

Here, m is a difference Δt in a cross section which is selected from among a plurality of cross sections along the thickness direction of the electrode group such that the difference Δt becomes greatest, the difference Δt being a difference between a thickness t1 of a part T1 in which a thickness of the electrode group in the thickness direction is minimum and a thickness t2 of a part T2 in which the thickness of the electrode group in the thickness direction is maximum. L is a maximum length of the electrode group in an in-plane direction that is orthogonal to the thickness direction.

According to the second embodiment, a secondary battery is provided. The secondary battery includes the electrode structure according to the first embodiment.

According to the third embodiment, a battery pack is provided. The battery pack includes the secondary battery according to the second embodiment.

According to the fourth embodiment, a vehicle is provided. The vehicle includes the battery pack according to the third embodiment.

According to the fifth embodiment, a stationary power supply is provided. The stationary power supply includes the battery pack according to the third embodiment.

Hereinafter, embodiments will be described with reference to the drawings as appropriate. The same reference numerals are assigned to the common components throughout embodiments, and overlapping explanation thereof is omitted. The respective drawings are schematic views for promoting the explanation and understanding of the embodiments. Therefore, although the shapes, dimensions, and ratios of the components may be different from those in actual apparatuses, their design may be appropriately changed in consideration of the following explanation and known techniques.

As typical examples of an electrode group including a positive electrode, a negative electrode and a separator interposed between the positive electrode and the negative electrode, there are known two kinds of forms, namely a wound electrode group and a stacked electrode group. When each of these electrode groups is manufactured, the electrode group is compressed, for example, in order to improve the volume energy density. In one example of the stacked electrode group, a positive electrode, a separator and a negative electrode are stacked in the named order. Two hold plates are disposed on both surfaces (on the positive electrode and on the negative electrode) of the electrode group, and clamp the electrode group. Then, the two hold plates are fixed so as to approach each other. Thereby, an electrode structure, in which the stacked electrode group is clamped, can be obtained. When the two hold plates are fixed, however, there is a certain level of difficulty in uniformizing the pressure, which acts on one surface (e.g. positive electrode surface) and/or the other surface (e.g. negative electrode surface) of the electrode group, within the surface.

The inventors have found that when the pressure (also called “fastening pressure”) acting on the electrode group clamped between the hold plates is not uniform within at least one of the surfaces of the electrode group, the coulomb efficiency lowers. This tendency is conspicuous, in particular, in a secondary battery using an aqueous electrolyte including water as a solvent.

In the negative electrode of the secondary battery including the aqueous electrolyte, since hydrogen overvoltage is low, electrolysis of water may occur as a side reaction. By the electrolysis of water, a chemical reaction indicated by a formula (A) below occurs in the negative electrode, and a chemical reaction indicated by a formula (B) below occurs in the positive electrode.

2H₂O+2e⁻→2OH⁻+H₂ (A)

2H₂O→O₂+4H⁺+4e⁻ (B)

If electrolysis of water occurs, as indicated by the above formula (A), hydrogen gas occurs and OH⁻ is generated near the negative electrode. Thus, there is a tendency that the pH of the aqueous electrolyte increases locally in that part of the negative electrode surface, which easily comes in contact with the aqueous electrolyte.

When the pressure acting on at least one of the surfaces of the electrode group is not uniform within the surface, local non-uniformity of the pH occurs and it is considered that the coulomb efficiency lowers due to such a part with the local non-uniformity of the pH. In addition, in the case of the secondary battery including the aqueous electrolyte, since the current collector can be dissolved in the aqueous electrolyte, there is a problem that a negative electrode active material-containing layer provided on the current collector is easily peeled from the current collector. The peeling of the active material-containing layer from the current collector is a factor which lowers the capacity of the secondary battery. According to an electrode structure relating to an embodiment described below, the pressure acting on at least one surface of the electrode group can be made sufficiently uniform within the surface, an excellent charge-and-discharge efficiency can be achieved.

### First Embodiment

An electrode structure according to a first embodiment includes an electrode group and a hold member. The hold member clamps the electrode group in a thickness direction of the electrode group. The electrode group satisfies a formula (1) below.

m/L≤0.01 (1)

Here, m is a difference Δt in a cross section which is selected from among a plurality of cross sections along the thickness direction of the electrode group such that the difference Δt becomes greatest, the difference Δt being a difference between a thickness t1 of a part T1 in which a thickness of the electrode group in the thickness direction is minimum and a thickness t2 of a part T2 in which the thickness of the electrode group in the thickness direction is maximum. L is a maximum length of the electrode group in an in-plane direction that is orthogonal to the thickness direction.

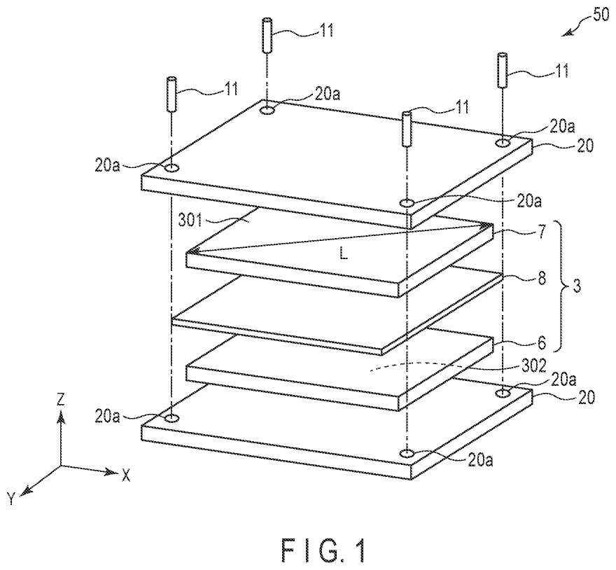

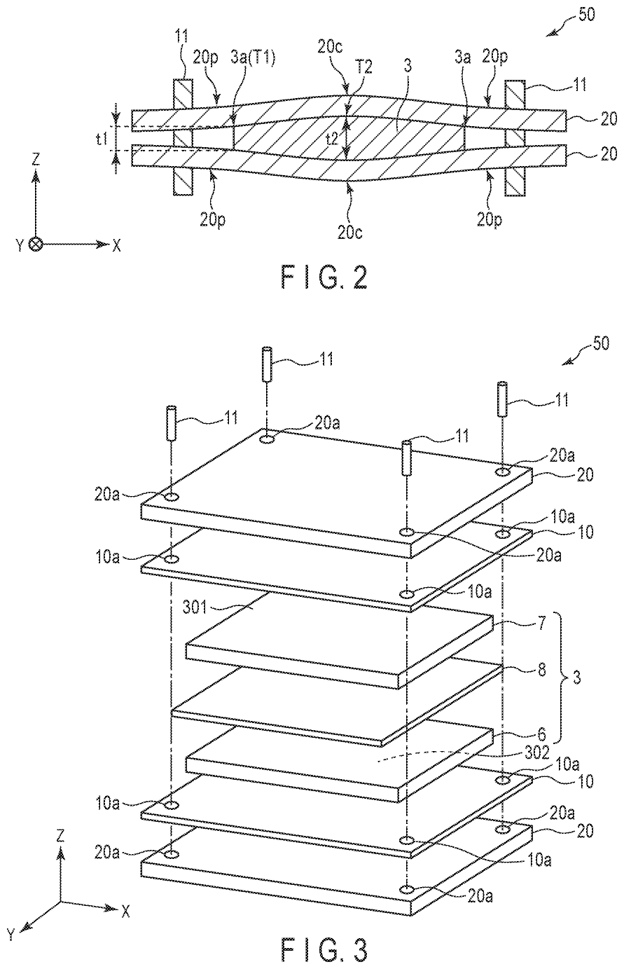

FIG. 1 and FIG. 2 illustrate an example of the electrode structure according to the embodiment. In the description below, an X-axis direction and a Y-axis direction are parallel to a major surface of an electrode group 3 and are orthogonal to each other. In addition, a Z-axis direction is a direction perpendicular to the X-axis direction and the Y-axis direction. Specifically, the Z-axis direction is a thickness direction. FIG. 1 is an exploded perspective view of an electrode structure according to one example. FIG. 2 illustrates a cross section of the electrode structure shown in FIG. 1, the cross section being perpendicular or substantially perpendicular to the Y-axis direction of the electrode structure.

An electrode structure 50 includes the electrode group 3, and hold members 20 which are stacked on both surfaces of the electrode group 3. The electrode group 3 and the hold members 20 are stacked in the Z-axis direction (thickness direction).

The electrode group 3 includes a positive electrode 7, a negative electrode 6, and a separator 8 interposed between the positive electrode 7 and the negative electrode 6. Here, each of the positive electrode 7, negative electrode 6 and separator 8 has a rectangular sheet shape. The shape of each of the positive electrode 7, negative electrode 6 and separator 8 is not limited to the rectangular shape, and may be a square shape, a circular shape or an elliptic shape. The details of the positive electrode 7, negative electrode 6 and separator 8 will be described in a second embodiment that is to be described later. The same positive electrode, negative electrode and separator as in a secondary battery according to the second embodiment can be used as the positive electrode, negative electrode and separator included in the electrode structure according to the present embodiment (first embodiment). As will be described later, the electrode group can include one or more negative electrodes, one or more positive electrodes, and one or more separators, and the negative electrodes and the positive electrodes can alternately be arranged via the separators. The electrode group according to the embodiment may be a stacked electrode group.

The electrode group 3 can include a first major surface 301 which faces one hold member 20, and a second major surface 302 which faces the other hold member 20. The second major surface 302 is located on an opposite side to the first major surface 301 with reference to the electrode group 3. The entirety of the first major surface 301 may be in contact with the hold member 20. The entirety of the second major surface 302 may be in contact with the hold member 20. As illustrated in FIG. 1, the first major surface 301 may be a major surface of the positive electrode 7. Alternatively, the first major surface 301 may be a major surface of the negative electrode 6, or may be a major surface of the separator 8. As illustrated in FIG. 1, the second major surface 302 may be a major surface of the negative electrode 6. Alternatively, the second major surface 302 may be a major surface of the positive electrode 7, or may be a major surface of the separator 8. Each of the positive electrode 7 and negative electrode 6 can include a positive electrode current-collecting tab (not shown) and a negative electrode current-collecting tab (not shown).

Note that in the present specification and the patent claims, the term “facing” means that one member and another member directly face each other. In the present specification and the patent claims, the term “opposed” means that one member and another member may directly contact and face each other, or a still another member may be interposed therebetween.

The electrode structure 50 includes fixing members 11 which fixes the two hold members 20 to each other in the state in which the two hold members 20 clamp both surfaces of the electrode group 3. Both surfaces of the electrode group 3 can be clamped by one of plural (two in this example) hold members and another of the hold members in a thickness direction of the electrode group 3. The fixing members 11 has a function of clamping the electrode group 3 by the two hold members, and keeping a stacked structure of the one hold member 20, the electrode group 3 and the other hold member 20. For example, the fixing members 11 can fix the position of the electrode group 3, which is fastened by the two hold members, such that the position of the electrode group 3 does not change from a predetermined position. Examples of the fixing members 11 include a bolt including a to-be-fastened portion, and a nut including a fastening portion which is engaged with the to-be-fastened portion.

As will be described later with reference to FIG. 5, it is possible to fix the electrode group 3 by the hold member 20 by utilizing plastic deformation of a metal or the like, without using the fixing members. In this case, the number of hold members 20 may be one. In other words, the number of hold members 20, which the electrode structure according to the embodiment includes, may be one or more. The number of hold members may be two, or three or more.

The hold member 20 is, for example, a flat plate-shaped member containing a resin or a metal. The hold member 20 can include one or more through-holes 20a. The one or more through-holes 20a are provided, for example, near a peripheral part of the hold member 20. When the hold member 20 has a substantially rectangular or substantially square flat plate shape, the one or more through-holes 20a are located, for example, on a diagonal of the rectangular or square shape. It is preferable that the through-hole 20a is provided at such a position that the distance from one side surface (not the major surface), which the rectangular or square shape has, is substantially equal to the distance from another side surface which neighbors the one side surface. Thereby, when the electrode group 3 is fastened by the two hold members 20, the pressure acting on at least one of the surfaces of the electrode group can easily be made uniform, and this is preferable. The number of through-holes 20a is, typically, four or more.

The hold member 20 may be a clamping member having a U-shape. Specifically, it suffices if the hold member has such a shape as to be able to clamp the electrode group. There may be a case in which the electrode group is camped by at least two plate-shaped hold members, a case in which the electrode group is clamped by the U-shaped hold member, and a case in which the electrode group is clamped by a cylindrical hold member.

The Young's modulus of the hold member 20 is, for example, 0.1 GPa or more. The hold member 20 may be made of one kind of material, or may include two or more kinds of materials. As illustrated in FIG. 1 and FIG. 2, when the electrode group 3 is clamped by the two hold members 20, the hold member 20 may be required to have a certain rigidity. From this standpoint, the Young's modulus of the hold member is, preferably, 1 GPa or more, and more preferably, 10 GPa or more. Although a higher Young's modulus of the hold member is desirable, the Young's modulus is 300 GPa or less according to one example.

An example of the material used for the hold member 20 is at least one kind selected from the group consisting of stainless steel (Fe—Ni—Cr), copper, iron, titanium, nickel, aluminum, steel (Fe—C), silicon steel (Fe—Si), an alloy, PEEK (Poly Ether Ether Ketone), PPS (Polyphenylenesulfide), PP (Polyprophylene), PE (Polyethylene), ABS (Acrylonitrile butadiene styrene copolymer), PS (Polystyrene), PC (Polycarbonate), PTFE (polytetrafluoroethylene), Oiles Aramid, PVC (polyvinyl chloride), a phenol resin, a melamine resin, a urea resin, an alkyd resin, an epoxy resin, polyurethane, polyester and polyacetal. The above-mentioned alloy may include two or more kinds selected from the group consisting of iron, Cr, nickel, Cu and Al.

The thickness of the hold member 20 is, for example, in a range of 3 mm to 50 mm, and preferably, in a range of 5 mm to 20 mm. As the thickness of the hold member 20 becomes greater, the hold member 20 is less easily bendable, and this is preferable. However, if the thickness of the hold member 20 is excessively large, such a disadvantage as a decrease in battery capacity, for instance, will occur. Thus, it is preferable that the thickness of the hold member 20 is not excessively large. The ratio of the thickness of one hold member to the thickness of the electrode group is, for example, in a range of 0.1% to 50%, and preferably, in a range of 1% to 25%.

As illustrated in FIG. 5, when the electrode group 3 is fixed by one hold member 20, the hold member may be, for example, a metallic can having a bottomed rectangular cylindrical shape. In this manner, the hold member 20 may double as a container member.

In the electrode structure 50 illustrated in FIG. 1 and FIG. 2, each of the plural fixing members 11 penetrates the through-holes 20a which the two hold members 20 have, at a position where the through-holes 20a correspond to each other, thereby fixing the two hold members 20. The fixing members 11, however, does not penetrate the electrode group 3. In the electrode structure 50, for example, as illustrated in FIG. 1 and FIG. 2, the dimensions of the electrode group 3 in the X-axis direction and Y-axis direction are less than the dimensions of the hold member 20 in the X-axis direction and Y-axis direction. Thus, by applying a pressure on the two hold members 20 in the Z-axis direction by using the fixing members 11 such that the two hold members 20 approach each other, peripheral parts of the hold members 20 can be bent. The fixing members 11 may be a member which can apply torque to the hold members 20.

FIG. 2 is a cross-sectional view schematically illustrating a state in which the peripheral parts of the two hold members 20 are bent. There is a case in which both end portions 3a of the electrode group 3 in the X-axis direction are crushed by the two hold members 20 fastening the electrode group 3. In FIG. 2, this case is schematically illustrated.

Among the end portions which the electrode group 3 includes, the end portions, which are crushed by the fastening by the hold members 20, are not limited to both end portions in the X-axis direction. For example, those portions of the electrode group 3, which are crushed by the fastening by the hold members 20, may be both end portions along the Y-axis direction. In addition, for example, those portions of the electrode group 3, which are crushed by the fastening by the hold members 20, may be both end portions of the electrode group 3 in a direction along an imaginary line connecting two through-holes 20a which the hold members 20 may have. Alternatively, the entirety of the end portions of the electrode group 3 may be crushed by the fastening by the hold members 20.

It is preferable that the electrode group 3 is not crushed even if the fastening pressure by the hold members 20 is applied to the electrode group 3, or the pressure is uniformly applied to at least one surface of the electrode group 3. In this case, compared to the case where at least a part of the electrode group 3 is crushed, an excellent charge-and-discharge efficiency can be achieved.

As illustrated in FIG. 2, if peripheral parts 20p of the two hold members 20 are bent in a manner to approach each other, central portions 20c of the two hold members 20 can be bent, for example, in a manner to move away from each other.

The electrode group 3, which the electrode structure 50 according to the embodiment includes, satisfies a formula (1).

m/L≤0.01 (1)

Here, m is a difference Δt in a cross section which is selected from among a plurality of cross sections along the thickness direction of the electrode group such that the difference Δt becomes greatest, the difference Δt being a difference between a thickness t1 of a part T1 in which a thickness of the electrode group in the thickness direction is minimum and a thickness t2 of a part T2 in which the thickness of the electrode group in the thickness direction is maximum. L is a maximum length of the electrode group in an in-plane direction that is orthogonal to the thickness direction.

The m/L is an index which indicates the degree of crushing of the electrode group. As the m/L becomes smaller, the m/L indicates that the uniformity of pressure acting on at least one surface of the electrode group is higher, and that the electrode group is not locally crushed. Therefore, according to an electrode structure including an electrode group with a smaller m/L, the electrode structure tends to exhibit a more excellent charge-and-discharge efficiency. Even if the size (dimensions) of the electrode group changes, the change in size is reflected on both the numerical value of m and the numerical value of L. Thus, by measuring the ratio m/L, the charge-and-discharge efficiency of the electrode structure can be evaluated without depending on the change in size of the electrode group. The method of determining m and L will be described later.

Note that when the fastening pressure by the fixing members, which acts on the hold members, is excessively small, there is a possibility that m takes a small value since the electrode group is not easily crushed. In this case, if the electrode structure is assembled in a secondary battery including an aqueous electrolyte, since the generation of gas becomes advantageous from the equilibrium theory, there is a tendency that a side reaction easily progresses. As a result, there is a possibility that the charge-and-discharge efficiency of the secondary battery and the cycle life characteristics lower.

Specifically, an equilibrium reaction in a case where attention is paid to the generation of H₂, which is a side reaction at the negative electrode, is as expressed by a formula (C) below.

2H⁺+2e⁻⇔H₂ (C)

In addition, when [H⁺], [H₂], and K are an H⁺ concentration, an H₂ concentration and an equilibrium constant, respectively, the equilibrium constant K is expressed by a formula (D1) below.

K=[H₂]/([H⁺]²) (D1)

Further, when R, T and p are a gas constant, a temperature of H₂, and a pressure of H₂, respectively, the equilibrium constant K is expressed by a formula (D2) below.

K=(p/RT)/([H⁺]²) (D2)

Here, since the temperature is regarded as being constant, the equilibrium constant K, gas constant R and temperature T are constants.

If pressure is applied to the negative electrode by the fastening pressure of the hold members, p increases, i.e., the pressure of the generated H₂ increases. Since K is the constant, H⁺ also increases accordingly. Specifically, if pressure is applied to the negative electrode, the equilibrium reaction shown by the formula (C) tends to easily progress in the left direction, and thus the generation of H₂ can be suppressed. Conversely speaking, if the pressure by the fastening member, which acts on the electrode group, is weak, the equilibrium reaction shown by the formula (C) tends to easily progress in the right direction, and thus there is a tendency that the generation of H₂ becomes advantageous.

The pressure acting on at least one surface of the electrode group 3 is, for example, 0.02 MPa or more, and preferably, 0.05 MPa or more, and more preferably, 0.1 MPa or more. According to one example, this pressure may be 100 MPa or less.

The pressure acting on at least one surface of the electrode group 3 can be measured in the following manner. To begin with, the thickness of the electrode group before disassembling of the electrode group is measured in advance. Then, the fastening of the hold members is released. Thereafter, the electrode group is clamped once again by one or a plurality of hold members, force is applied from the outside (for example, by a hydraulic press machine), and the force is applied until the electrode group has the thickness before the disassembling. The value of force at a time when the electrode group has the thickness before the disassembling is divided by the area of the major surface of the electrode group, and thereby the pressure can be calculated.

The axial tension acting on one fixing members is, for example, in a range of 1000 N to 10000 N. When the electrode structure includes, for example, four fixing members, the axial tension is multiplied by four, and the total axial tension may be in a range of 4000 N to 40000 N.

In FIG. 2, a part T1 in which the thickness of the electrode group 3 is minimum is a portion 3a which is crushed by the fastening by the hold members 20. In addition, a part T2 in which the thickness of the electrode group 3 is maximum is shown in FIG. 2. The part T2 is a portion of the electrode group 3 in a position where the distance from one major surface to the other major surface of the electrode group 3 is greatest. It is preferable that the part T2 which the electrode group 3 includes is in contact with both of the two hold members 20.

The m is a difference Δt (t2−t1) between a thickness t1 of the electrode group in the part T1 and a thickness t2 of the electrode group in the part T2. The m can also be called “displacement”. As far as the m/L is 0.01 or less, the value of m is not particularly limited, but m is, for example, 3000 μm or less, and preferably, 1000 μm or less, and more preferably, 100 μm or less. The value of m is, preferably, close to 0 μm, and the value of m may be 0 μm. The value of m may vary depending on the size of the electrode structure that is the object.

The L is a maximum length in an in-plane direction of the electrode group 3. The L in the electrode structure 50 shown in FIG. 1 and FIG. 2 may be, for example, a length of a diagonal of the positive electrode 7 or negative electrode 6 which is rectangular. Here, when L is determined, the dimensions or the length of the separator included in the electrode group is not considered. The reason for this is that the separator itself does not contribute to the electrode reaction. For example, even if the separator is greatly crushed, if the positive electrode or negative electrode is not substantially crushed, an excellent charge-and-discharge efficiency can be achieved. Accordingly, the maximum length L of the electrode group may be a maximum length in an in-plane direction of the positive electrode, or may be a maximum length in an in-plane direction of the negative electrode. On the other hand, when the displacement m is determined, the displacement m is determined by taking into account the thickness of the separator included in the electrode group.

As far as the m/L is 0.01 or less, the value of L is not limited, but the value of L is, for example, in a range of 50 mm to 10000 mm.

The m/L is, preferably, 0.001 or less, and more preferably, 0.0001 or less. Even if the dimensions of the electrode structure that is the object varies, as far as the m/L is 0.01 or less, the electrode structure can realize a secondary battery which can achieve an excellent charge-and-discharge efficiency.

Although the thickness of the electrode group is not particularly limited, the thickness is, for example, in a range of 2 mm to 1000 mm. It is preferable that the displacement m is small, relative to the thickness of the electrode group. The ratio of m to the thickness of the electrode group is, for example, 50% or less, and preferably, 30% or less, and more preferably, 10% or less. This ratio may be 0%. If this ratio is small, the crushing of the electrode group is small, and therefore there is a tendency that the generation of hydrogen is suppressed and an excellent charge-and-discharge efficiency can be achieved. Note that when the thickness of the electrode group assembled in a battery is measured, the thickness of the electrode group is set to be a value that is obtained by dividing by two the total of the thickness t1 in the part T1 and the thickness t2 in the part T2.

The area of at least one major surface of the electrode group is, for example, in a range of 10 cm² to 100000 cm².

Although the thickness of the electrode structure is not particularly limited, the thickness is, for example, in a range of 5 mm to 1000 mm.

In another mode, in order to decrease the m/L, the hold member 20 may have a substantially convex shape. Specifically, the hold member 20 may have a convex portion protruding toward the electrode group 3 at the contact surface between the hold member 20 and the electrode group 3. The convex portion that the hold member includes may be a part of the hold member. In the contact surface between the hold member and the electrode group, this surface of the hold member can have an arcuate shape protruding toward the electrode group side. When a part of the hold member 20 has such a convex shape, even if a peripheral part of the hold member 20 is bent, the central portion 20c of the hold member 20 can be prevented from moving away from the electrode group 20.

<Determination Method of m and L (X-Ray CT Observation)>

As regards the electrode group included in the electrode structure or the secondary battery, in order to determine m and L, computed tomography (CT) utilizing X-rays is used. As an X-ray CT observation apparatus, for example, the inspeXio SMX-225CT FPD Plus manufactured by SHIMADZU CORPORATION, or an apparatus having an equivalent function, can be used.

When the battery is modularized, the module is disassembled into unit cells. The unit cell, in this context, refers to a minimum unit of a battery, which is not subjected to battery disassembly and is not connected in parallel or in series as much as possible. There is a possibility that the strain of the unit cell is suppressed by the holding by the modularization. Thus, after the unit cell is left to stand for one day, X-ray CT observation is conducted. The observation is conducted at 25° C. at atmospheric pressure. The measurement is not conducted in a state in which force is applied to the unit cell itself by a weight or the like. Note that the unit cell corresponds to, for example, the electrode structure. By the X-ray CT observation, it is possible to select, from among cross sections along the thickness direction of the electrode group, a cross section in which the difference Δt becomes greatest between the thickness t1 of the part T1 in which the thickness of the electrode group in the thickness direction is minimum and the thickness t2 of the part T2 in which the thickness of the electrode group in the thickness direction is maximum. The difference Δt can be calculated by subtracting t1 from t2. The displacement m is Δt. In addition, from among a plurality of obtained cross sections, a cross section with a maximum length of the electrode group in an in-plane direction of the electrode group is selected. The maximum length in this cross section is set to be L.

Note that the above-described cross section selected for calculating Δt may agree with, or may not agree with, the cross section in which the maximum length L in the in-plane direction of the electrode group is present. In addition, as described above, when L is determined with respect to the electrode group, the length of the separator in the in-plane direction is not taken into account.

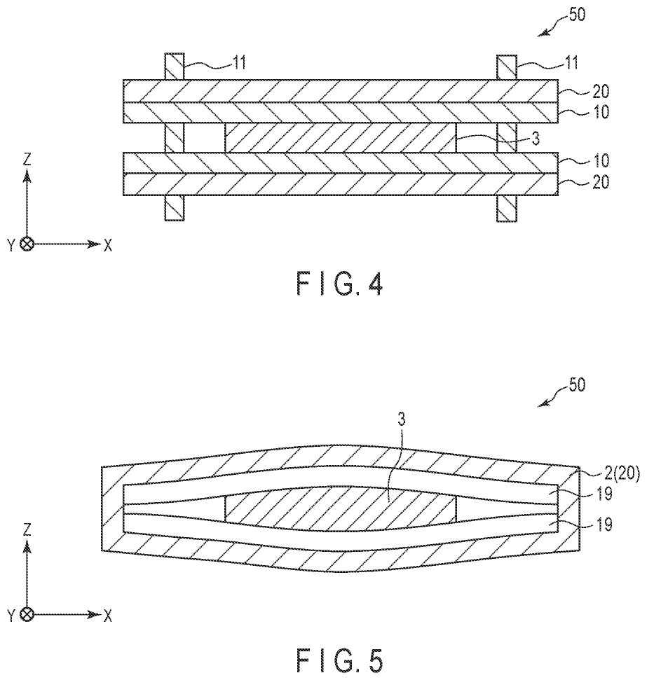

FIG. 3 and FIG. 4 illustrate another example of the electrode structure according to the embodiment. FIG. 3 is an exploded perspective view of the electrode structure according to the another example. FIG. 4 illustrates a cross section perpendicular or substantially perpendicular to the Y-axis direction of the electrode structure shown in FIG. 3.

An electrode structure 50 shown in FIG. 3 and FIG. 4 has the same configuration as the electrode structure 50 described with reference to FIG. 1 and FIG. 2, except that the electrode structure 50 shown in FIG. 3 and FIG. 4 includes a strain suppression member 10 between the electrode group 3 and the hold member 20. Specifically, in the electrode structure 50 shown in FIG. 3 and FIG. 4, two hold members 20 clamp the electrode group 3 via strain suppression members 10. The electrode group 3 includes a first major surface 301 which is opposed to one hold member 20, and a second major surface 302 which is opposed to the other hold member 20, the second major surface 302 being located on an opposite side to the first major surface 301 with reference to the electrode group 3. The strain suppression member 10 is interposed between the first major surface 301 of the electrode group 3 and one hold member 20, and/or between the second major surface 302 of the electrode group 3 and the other hold member 20. It is preferable that the strain suppression member 10 is disposed on each of both surfaces of the electrode group 3.

The shape of the strain suppression member 10 is not limited if the strain suppression member 10 can suppress the strain of the hold member 20. For example, the strain suppression member 10 is a flat plate-shaped member containing a resin or a metal. Like the hold member 20, the strain suppression member 10 can include one or more through-holes 10a. The one or more through-holes 10a are provided, for example, near a peripheral part of the strain suppression member 10. When the strain suppression member 10 has a substantially rectangular or substantially square flat plate shape, the one or more through-holes 10a are located, for example, on a diagonal of the rectangular or square shape. It is preferable that the through-hole 10a is provided at such a position that the distance from one side surface, which the rectangular or square shape has, is substantially equal to the distance from another side surface which neighbors the one side surface. Thereby, when the electrode group 3 is fastened by the two hold members 20 and the two strain suppression members 10, the pressure acting on at least one of the surfaces of the electrode group can easily be made uniform. The number of through-holes 10a is, typically, four or more.

The strain suppression member 10 may be a clamping member having a U-shape.

From the standpoint that the strain suppression member 10 suppresses the strain of the hold member 20, it is preferable that the strain suppression member 10 has a Young's modulus which is higher than the Young's modulus of the hold member 20. The strain suppression member 10 may be made of one kind of material, or may include two or more kinds of materials. The Young's modulus of the strain suppression member 10 is, for example, 10 GPa or more, and preferably, 100 GPa or more. Although a higher Young's modulus of the strain suppression member is desirable, the Young's modulus is 300 GPa or less according to one example.

An example of the material used for the strain suppression member 10 is at least one kind selected from the group consisting of stainless steel (Fe—Ni—Cr), copper, iron, titanium, nickel, aluminum, steel (Fe—C), silicon steel (Fe—Si), an alloy, PEEK (Poly Ether Ether Ketone), PPS (Polyphenylenesulfide), PP (Polyprophylene), PE (Polyethylene), ABS (Acrylonitrile butadiene styrene copolymer), PS (Polystyrene), PC (Polycarbonate), PTFE (polytetrafluoroethylene), Oiles Aramid, PVC (polyvinyl chloride), a phenol resin, a melamine resin, a urea resin, an alkyd resin, an epoxy resin, polyurethane, polyester and polyacetal. The above-mentioned alloy may include two or more kinds selected from the group consisting of iron, Cr, nickel, Cu and Al.

From the standpoint of suppressing the strain of the hold member, it is preferable that the material contained in the strain suppression member is a metal, and it is preferable that the material contained in the strain suppression member is, for example, stainless steel, copper, steel, aluminum and an alloy.

The thickness of the strain suppression member 10 is, for example, in a range of 0.1 mm to 100 mm, and preferably, in a range of 1 mm to 50 mm. As the thickness of the strain suppression member 10 becomes greater, the strain suppression member 10 and hold member 20 are less easily bendable, and this is preferable. However, if the thickness of the strain suppression member 10 is excessively large, such a disadvantage as a decrease in battery capacity, for instance, will occur. Thus, it is preferable that the thickness of the strain suppression member 10 is not excessively large.

Like the hold member, the strain suppression member may have a substantially convex shape. Specifically, the strain suppression member may have a convex portion protruding toward the electrode group at the contact surface between the strain suppression member and the electrode group. The convex portion that the strain suppression member includes may be a part of the strain suppression member. In the contact surface between the strain suppression member and the electrode group, this surface of the strain suppression member can have an arcuate shape protruding toward the electrode group side. When a part of the strain suppression member has such a convex shape, even if a peripheral part of the hold member and a peripheral part of the strain suppression member are bent, a part of the strain suppression member can be prevented from moving away from the electrode group.

The electrode structure 50 shown in FIG. 3 and FIG. 4 includes at least one strain suppression member 10. Thus, even if a fastening pressure is applied by the fixing members 11, the bending of the hold members 20 can be suppressed, for example, as illustrated in FIG. 4. As a result, crushing of at least a part of the electrode group 3 can be suppressed. In other words, the pressure acting on at least one major surface of the electrode group 3 can be made uniform within the surface by the strain suppression member 10. As a result, since the m decreases, the electrode structure in which the electrode group satisfies m/L≤0.01 can easily be obtained. Specifically, since the electrode structure including at least one strain suppression member 10 can reduce the local non-uniformity of the pH, the electrode structure can achieve an excellent charge-and-discharge efficiency.

FIG. 5 is a cross-sectional view schematically illustrating another example of the electrode structure according to the first embodiment. FIG. 5 illustrates a cross section perpendicular or substantially perpendicular to the Y-axis direction of the electrode structure. In the electrode structure 50 illustrated in FIG. 5, a container member 2 functions also as the hold member 20. By way of example, a case is illustrated here in which a metallic can having a bottomed rectangular cylindrical shape is used as the container member 2, and the electrode group 3 is fixed by utilizing plastic deformation of the container member 2. In the electrode structure 50 shown in FIG. 5, the electrode group 3 satisfies m/L≤0.01.

In the case where the inner surface of the container member 2 is metallic, if the container member 2 and the electrode group 3 come in contact, a voltage occurs and this is not preferable. In order to prevent this, for example, as illustrated in FIG. 5, insulative sheets 19 are stacked between the electrode group 3 and the container member 2. The insulative sheets 19 can be used not only in the mode illustrated in FIG. 5, but also in the electrode structure described with reference to FIG. 1 and FIG. 2 and in the electrode structure described with reference to FIG. 3 and FIG. 4. In any of the cases, the electrode structure can include the insulative sheet on at least one major surface of the electrode group.

According to one example, the insulative sheet 19 includes an insulative polymeric material. The insulative sheet 19 includes, for example, at least one kind selected from the group consisting of polytetrafluoroethylene (PTFE), cellophane, PEEK (Poly Ether Ether Ketone), PPS (Polyphenylenesulfide), PP (Polyprophylene), PE (Polyethylene), ABS (Acrylonitrile butadiene styrene copolymer), PS (Polystyrene), PC (Polycarbonate), Oiles Aramid, PVC (polyvinyl chloride), a phenol resin, a melamine resin, a urea resin, an alkyd resin, an epoxy resin, polyurethane, polyester and polyacetal.

Although the thickness of the insulative sheet is not particularly limited, the thickness is, for example, in a range of 0.01 mm to 10 mm.

Means for applying a fastening pressure to the container member 2 is not particularly limited. For example, it is possible to apply a fastening pressure to the container member 2 by utilizing, for example, a heat-shrinkable tape or the like.

According to the first embodiment, an electrode structure is provided. The electrode structure includes an electrode group and a hold member. The hold member clamps the electrode group in a thickness direction of the electrode group. The electrode group satisfies a formula (1) below.

m/L≤0.01 (1)

Here, m is a difference Δt in a cross section which is selected from among a plurality of cross sections along the thickness direction of the electrode group such that the difference Δt becomes greatest, the difference Δt being a difference between a thickness t1 of a part T1 in which a thickness of the electrode group in the thickness direction is minimum and a thickness t2 of a part T2 in which the thickness of the electrode group in the thickness direction is maximum. L is a maximum length of the electrode group in an in-plane direction that is orthogonal to the thickness direction. According to the electrode structure of the embodiment, since the uniformity of the pressure acting on at least one surface of the electrode group is high, an excellent charge-and-discharge efficiency can be achieved.

### Second Embodiment

According to a second embodiment, there is provided a secondary battery including the electrode structure according to the embodiment. The secondary battery can further include an aqueous electrolyte. The aqueous electrolyte can be held by, for example, the electrode group which the electrode structure includes.

The secondary battery can further include a container member which accommodates the electrode structure and the aqueous electrolyte. In addition, the secondary battery can further include a negative electrode terminal which is electrically connected to the negative electrode, and a positive electrode terminal which is electrically connected to the positive electrode.

The secondary battery may be an alkali metal ion secondary battery such as a lithium ion secondary battery or a sodium ion secondary battery.

Hereinafter, the negative electrode, the positive electrode, the aqueous electrolyte, the separator, the container member, the negative electrode terminal, and the positive electrode terminal will be described in detail.

(1) Negative Electrode

The negative electrode can include a negative electrode current collector, and a negative electrode active material-containing layer which is supported on one surface or both surfaces of the negative electrode current collector. The negative electrode active material-containing layer can include a negative electrode active material, and, discretionarily, a conductive agent and a binder.

As the material of the negative electrode current collector, a substance that is electrochemically stable in the negative electrode potential range when the alkali metal ions are inserted or extracted is used. The negative electrode current collector is preferably, for example, a zinc foil, an aluminum foil or an aluminum alloy foil containing at least one element selected from the group consisting of magnesium (Mg), titanium (Ti), zinc, manganese (Mn) iron (Fe), copper (Cu), and silicon (Si). The negative electrode current collector may have another form such as a porous body or a mesh. The thickness of the negative electrode current collector is preferably from 5 μm to 30 μm. A current collector having such a thickness can balance the strength of the electrode and weight reduction.

The negative electrode current collector may include a portion where the negative electrode active material-containing layer is not formed on a surface of the negative electrode current collector. This portion can serve as a negative electrode tab.

As the negative electrode active material, use can be made of a compound having a lithium ion insertion/extraction potential in a range of 1 V (vs. Li/Li⁺) or more to 3 V (vs. Li/Li⁺) or less relative to metal lithium potential. As the negative electrode active material, use can be made of, specifically, a titanium-containing oxide such as titanium oxide, lithium-titanium composite oxide, a niobium-titanium composite oxide, and a sodium-niobium-titanium composite oxide. The negative electrode active material can include one kind, or two or more kinds, of titanium-containing oxides.

The titanium oxide includes, for example, a titanium oxide having a monoclinic structure, a titanium oxide having a rutile structure, and a titanium oxide having an anatase structure. For titanium oxides of these crystal structures, the composition before charge can be expressed as TiO₂, and the composition after charge can be expressed as LiₓTiO₂ (0≤x≤1). In addition, the structure of titanium oxide having a monoclinic structure before charge can be expressed as TiO₂(B).

The lithium titanium composite oxide includes, for example, a lithium titanium composite oxide having a spinel structure (for example, the general formula is Li₄₊ₓTi₅O₁₂ (−1≤x≤3)), a lithium titanium composite oxide having a ramsdellite structure (for example, Li₂₊ₓTi₃O₇ (−1≤x≤3)), Li₁₊ₓTi₂O₄ (0≤x≤1), Li_{1.1+x}Ti_{1.8}O₄ (0≤x≤1), Li_{1.07+x}Ti_{1.86}O₄ (0≤x≤1), and LiₓTiO₂ (0<x≤1), and the like. The lithium titanium composite oxide may be a lithium titanium composite oxide in which a dopant is introduced.

The niobium-titanium composite oxide has, for example, a monoclinic crystal structure. The monoclinic niobium-titanium composite oxide is, for example, at least one selected from the group consisting of a composite oxide represented by General Formula LiₓTi_{1-y}M1_{y}Nb_{2-z}M2_{z}O_{7+δ}, and a composite oxide represented by General Formula LiₓTi_{1-y}M3_{y+z}Nb_{2-z}O_{7-δ}. Here, M1 is at least one selected from the group consisting of Zr, Si, and Sn. M2 is at least one selected from the group consisting of V, Ta, and Bi. M3 is at least one selected from the group consisting of Mg, Fe, Ni, Co, W, Ta, and Mo. Each subscript in the composition formula satisfies 0≤x≤5, 0≤y<1, 0≤z<2, and −0.3≤δ≤0.3.

Specific examples of the monoclinic niobium-titanium composite oxides include Nb₂TiO₇, Nb₂Ti₂O₉, Nb₁₀Ti₂O₂₉, Nb₁₄TiO₃₇, and Nb₂₄TiO₆₂. The monoclinic niobium-titanium composite oxide may be a substituted niobium-titanium composite oxide in which at least a part of Nb and/or Ti is substituted with a dopant. Examples of substitution elements are Na, K, Ca, Co, Ni, Si, P, V, Cr, Mo, Ta, Zr, Mn, Fe, Mg, B, Pb, and Al. The substituted niobium-titanium composite oxide may include one kind or two or more kinds of the substitution elements.

The sodium titanium oxides include, for example, an orthorhombic Na-containing niobium titanium composite oxide represented by the general formula Li₂₊ᵥNa_{2-w}M1ₓTi_{6-y-z}Nb_{y}M2_{z}O_{14+δ}, (0≤v≤4, 0≤w<2, 0≤x<2, 0≤y<6, 0≤z<3, −0.5≤δ≤0.5, M1 includes at least one element selected from the group consisting of Cs, K, Sr, Ba, and Ca, and M2 includes at least one element selected from the group consisting of Zr, Sn, V, Ta, Mo, W, Fe, Co, Mn, and Al).

As the negative electrode active material, the titanium oxide having the anatase structure, the titanium oxide having the monoclinic structure, the lithium titanium composite oxide having the spinel structure, the niobium-titanium composite oxides or a mixture thereof is preferably used. When one of these oxides is used as the negative electrode active material and a lithium manganese composite oxide is used as the positive electrode active material, a high electromotive force can be obtained.

The negative electrode active material is contained in the negative electrode active material-containing layer in a form of, for example, particles. The negative electrode active material particles can be primary particles, secondary particles as the aggregates of primary particles, or a mixture of single primary particles and secondary particles. The shape of a particle is not particularly limited and can be, for example, spherical, elliptical, flat, or fibrous.

An average particle size (diameter) of primary particles of the negative electrode active material is preferably 3 μm or less and more preferably 0.01 μm or more and 1 μm or less. An average particle size (diameter) of secondary particles of the negative electrode active material is preferably 30 μm or less and more preferably 5 μm or more and 20 μm or less.

Each of the primary particle size and the secondary particle size means a particle size with which a volume integrated value becomes 50% in a particle size distribution obtained by a laser diffraction particle size distribution measuring apparatus. As the laser diffraction particle size distribution measuring apparatus, Shimadzu SALD-300 is used, for example. For measurement, luminous intensity distribution is measured 64 times at intervals of 2 seconds. As a sample used when performing the particle size distribution measurement, a dispersion obtained by diluting the negative electrode active material particles by N-methyl-2-pyrrolidone such that the concentration becomes 0.1 wt % to 1 wt % is used. Alternatively, a measurement sample obtained by dispersing 0.1 g of a negative electrode active material in 1 to 2 ml of distilled water containing a surfactant is used.

Examples of the conductive agent include carbonaceous materials such as acetylene black, Ketjen black, graphite, and coke. The conductive agent may be of one type, or two or more types may be used in mixture.

Examples of the conductive agent include carbonaceous materials such as acetylene black, Ketjenblack, carbon nanofibers, carbon nanotubes, graphite, and coke. As the conductive agent, one kind may be used, or two or more kinds may be mixed and used.

Examples of the binder include polytetrafluoroethylene (PTFE), polyvinylidene fluoride (PVdF), fluorine-containing rubber, styrene butadiene rubber, polyacrylate compound, imide compound, carboxymethyl cellulose (CMC), and a salt of CMC. One of them may be used as the binder, or two or more of them may be combined for use as the binder.

Preferred percentages of mixing of the negative electrode active material, the conductive agent and the binder in the negative electrode active material-containing layer, are given by the range from 70% by mass to 95% by mass for the negative electrode active material, by the range from 3% by mass to 20% by mass for the conductive agent, and by the range from 2% by mass to 10% by mass for the binder. With the percentage of mixing of the conductive agent adjusted to 3% by mass or larger, current collection performance of the negative electrode active material-containing layer may be improved. With the percentage of mixing of the binder adjusted to 2% by mass or larger, a sufficient level of electrode strength is obtainable, meanwhile with the percentage adjusted to 10% by mass or smaller, insulating parts in the electrode may be reduced.

The negative electrode can be obtained by, for example, the following method. First, the active material, the conductive agent, and the binder are suspended in an appropriate solvent to prepare a slurry. Next, the slurry is applied to one surface or both surfaces of the current collector. The coating on the current collector is dried, thereby forming an active material-containing layer. After that, pressing is performed for the current collector and the active material-containing layer formed on it. As the active material-containing layer, the mixture of the active material, the conductive agent, and the binder formed into pellets may be used.

(2) Positive Electrode

The positive electrode can include a positive electrode current collector and a positive electrode active material-containing layer supported on the positive electrode current collector.

The positive electrode current collector is made of, for example, a metal such as stainless steel, aluminum (Al), or titanium (Ti). The positive electrode current collector has a form of, for example, a foil, a porous body, or a mesh. To prevent corrosion by the reaction between the positive electrode current collector and the aqueous electrolyte, the surface of the positive electrode current collector may be covered with a different kind of element. The positive electrode current collector is preferably made of a material with excellent corrosion resistance and oxidation resistance, for example, a Ti foil. Note that when the aqueous electrolyte contains Li₂SO₄, Al may be used as the positive electrode current collector because corrosion does not progress.

The thickness of the positive electrode current collector is, preferably, 5 μm or more to 20 μm or less, and more preferably, 15 μm or less.

In addition, the positive electrode current collector can include a portion with a surface on which the positive electrode active material-containing layer is not formed. This portion can function as a positive electrode current-collecting tab.

The positive electrode active material-containing layer contains the positive electrode active material. The positive electrode active material-containing layer may be supported on each main surface of the positive electrode current collector. As the positive electrode active material, a compound whose lithium ion insertion/extraction potential is 2.5 V (vs. Li/Li⁺) to 5.5 V (vs. Li/Li⁺) as a potential based on metal lithium can be used. The positive electrode may contain one type of positive electrode active material or may contain two or more types of positive electrode active materials.

Examples of the positive electrode active material include a lithium manganese composite oxide, a lithium nickel composite oxide, a lithium cobalt aluminum composite oxide, a lithium nickel cobalt manganese composite oxide, a spinel type lithium manganese nickel composite oxide, a lithium manganese cobalt composite oxide, a lithium iron oxide, a lithium fluorinated iron sulfate, a phosphate compound having an olivine crystal structure (for example, LiₓFePO₄ (0<x≤1), LiₓMnPO₄ (0<x≤1)), and the like. The phosphate compound having an olivine crystal structure has excellent thermal stability.

Examples of the positive electrode active material capable of obtaining a high positive electrode potential are a lithium manganese composite oxide having a spinel structure such as LiₓMn₂O₄ (0<x≤1) or LiₓMnO₂ (0<x≤1), a lithium nickel aluminum composite oxide such as LiₓNi_{1-y}Al_{y}O₂ (0<x≤1, and 0<y<1), a lithium cobalt composite oxide such as LiₓCoO₂ (0<x≤1), a lithium nickel cobalt composite oxide such as LiₓNi_{1-y-z}Co_{y}Mn_{z}O₂ (0<x≤1, 0<y<1, and 0≤z<1), a lithium manganese cobalt composite oxide such as LiₓMn_{y}Co_{1-y}O₂ (0<x≤1, and 0<y<1), a spinel type lithium manganese nickel composite oxide such as LiₓMn_{1-y}Ni_{y}O₄ (0<x≤1, 0<y<2, and 0<1−y<1), a lithium phosphorus oxide such as having an olivine structure such as LiₓFePO₄ (0<x≤1), LiₓFe_{1-y}Mn_{y}PO₄ (0<x≤1, 0≤y≤1), or LiₓCoPO₄ (0<x≤1), and a fluorinated iron sulfate (for example, LiₓFeSO₄F (0<x≤1)).

The positive electrode active material is preferably at least one material selected from the group consisting of a lithium cobalt composite oxide, a lithium manganese composite oxide, and a lithium phosphorus oxide having an olivine structure. The operating potentials of these active materials are 3.5 V (vs. Li/Li⁺) to 4.2 V (vs. Li/Li⁺). That is, the operating potentials of these active materials are relatively high. When these positive electrode active materials are used in combination with the above-described negative electrode active material such as a spinel type lithium titanate or an anatase type titanium oxide, a high battery voltage can be obtained.

The positive electrode active material is contained in the positive electrode in a form of, for example, particles. The positive electrode active material particles can be single primary particles, secondary particles as the aggregates of primary particles, or a mixture of primary particles and secondary particles. The shape of a particle is not particularly limited and can be, for example, spherical, elliptical, flat, or fibrous.

The average particle size (diameter) of the primary particles of the positive electrode active material is preferably 10 μm or less, and more preferably 0.1 μm to 5 μm. The average particle size (diameter) of the secondary particles of the positive electrode active material is preferably 100 μm or less, and more preferably 10 μm to 50 μm.

The primary particle size and the secondary particle size of the positive electrode active material can be measured by the same method as that for the negative electrode active material particles.

In addition to the positive electrode active material, the positive electrode active material-containing layer may contain a conductive agent, a binder, and the like. A conductive agent is added as necessary in order to increase the current-collecting performance and to suppress the contact resistance between the active material and the current collector. The binder has an action of binding the active material, the conductive agent, and the current collector.

Examples of the conductive agent include carbonaceous materials such as acetylene black, Ketjenblack, carbon nanofibers, carbon nanotubes, graphite, and coke. As the conductive agent, one kind may be used, or two or more kinds may be mixed and used.

In the positive electrode active material-containing layer, preferred percentages of mixing of the positive electrode active material and the binder are within the range from 80% by mass to 98% by mass, and from 2% by mass to 20% by mass, respectively.

With the content of the binder adjusted to 2% by mass or more, a sufficient level of electrode strength is obtainable. The binder can also function as an insulator. Hence, with the content of binder adjusted to 20% by mass or less, the amount of insulator contained in the electrode decreases, and thereby the internal resistance may be lowered.

In a case where the conductive agent is added, percentages of mixing of the positive electrode active material, the binder, and the conductive agent are preferably within the range from 77% by mass to 95% by mass, from 2% by mass to 20% by mass, and from 3% by mass to 15% by mass, respectively.

With the amount of conductive agent adjusted to 3% by mass or more, the aforementioned effects may be demonstrated. Meanwhile, with the amount of conductive agent adjusted to 15% by mass or less, percentage of the conductive agent possibly brought into contact with the electrolyte may be reduced. With the percentage suppressed low, the electrolyte may be suppressed from being decomposed during storage at high temperature.

The positive electrode can be obtained by, for example, the following method. First, the active material, the conductive agent, and the binder are suspended in an appropriate solvent to prepare a slurry. Next, the slurry is applied to one surface or both surfaces of the current collector. The coating on the current collector is dried, thereby forming an active material-containing layer. After that, pressing is performed for the current collector and the active material-containing layer formed on it. As the active material-containing layer, the mixture of the active material, the conductive agent, and the binder formed into pellets may be used.

(3) Separator

A separator may be disposed between a positive electrode and a negative electrode. When the separator is constituted of an insulating material, electrical contact between the positive electrode and the negative electrode can be prevented. Examples of the separator include nonwoven fabrics, films, and paper. Examples of materials forming the separator include polyolefin, such as polyethylene and polypropylene, and cellulose. Preferable examples of the separator include nonwoven fabrics containing cellulose fibers and porous films containing polyolefin fibers. The porosity of the separator is preferably 60% or more. A fiber diameter is preferably 10 μm or less. When the fiber diameter is 10 μm or less, an affinity of the separator with an electrolyte is enhanced, so that battery resistance can be reduced. A more preferable range of the fiber diameter is 3 μm or less. In a cellulose fiber containing nonwoven fabric having a porosity of 60% or more, impregnation of an electrolyte is good, and high output performance can be exhibited from low temperature to high temperature. The separator does not react with a negative electrode in long term charged storage, float charging, and over-charge, and a short-circuit between the negative electrode and the positive electrode due to dendrite precipitation of lithium metal does not occur. A more preferable range is 62% to 80%.

It is preferable that the separator has a thickness of 20 μm to 100 μm and a density of 0.2 g/cm³ to 0.9 g/cm³. If the thickness and the density of the separator are in these ranges, mechanical strength and a reduction in battery resistance can be balanced, so that a secondary battery in which an internal short-circuit is suppressed by a high output can be provided. Heat shrinkage of the separator under a high temperature environment is small, and good high temperature storage performance can be exhibited.

As a separator, a solid electrolyte layer including solid electrolyte particles can also be used. The solid electrolyte layer may include one type of solid electrolyte particles or may include plural types of solid electrolyte particles. The solid electrolyte layer may be a solid electrolyte composite film including solid electrolyte particles. The solid electrolyte composite film is obtained by, for example, forming solid electrolyte particles into a film shape using a polymer binder. The solid electrolyte layer may contain at least one selected from the group consisting of a plasticizer and an electrolyte salt. When the solid electrolyte layer contains an electrolyte salt, for example, alkali metal ion conductivity of the solid electrolyte layer can be further enhanced.

Examples of a polymer binder include polyether type, polyester type, polyamine type, polyethylene type, silicone type and polysulfide type.

As the solid electrolyte particles, an inorganic solid electrolyte is preferably used. As the inorganic solid electrolyte, for example, an oxide-based solid electrolyte or a sulfide-based solid electrolyte can be used. As the oxide-based solid electrolyte, a lithium phosphate solid electrolyte having a NASICON structure and represented by a general formula LiM₂(PO₄)₃ is preferably used. M in the formula is preferably at least one element selected from the group consisting of titanium (Ti), germanium (Ge), strontium (Sr), zirconium (Zr), tin (Sn), and aluminum (Al). The element M preferably includes Al and one of Ge, Zr, and Ti.

Detailed examples of the lithium phosphate solid electrolyte having the NASICON structure include LATP (Li₁₊ₓAlₓTi₂₋ₓ(PO₄)₃) Li₁₊ₓAlₓGe₂₋ₓ(PO₄)₃, and Li₁₊ₓAlₓZr₂₋ₓ(PO₄)₃. In the above formula, x falls within the range of 0<x≤5, x preferably falls within the range of 0<x≤2, x more preferably falls within the range of 0.1≤x≤0.5. As the solid electrolyte, LATP is preferably used. LATP is excellent in waterproofness and hardly causes hydrolysis in the secondary battery.

As the oxide-based solid electrolyte, LIPON (Li_{2.9}PO_{3.3}N_{0.46}) in an amorphous state or LLZ (Li₇La₃Zr₂O₁₂) having a garnet structure may be used.

As the solid electrolyte, a sodium containing solid electrolyte may be used. The sodium containing solid electrolyte is excellent in the ionic conductivity of sodium ions. As the sodium containing solid electrolyte, β-alumina, a sodium phosphorus sulfide, a sodium phosphorus oxide, or the like can be used. The sodium ions containing solid electrolyte preferably has a glass-ceramic form.

As the electrolyte salt, a lithium salt, a sodium salt, or a mixture thereof is preferably used. One type or two or more types of electrolyte salts can be used.

As the lithium salt, for example, lithium chloride (LiCl), lithium bromide (LiBr), lithium hydroxide (LiOH), lithium sulfate (Li₂SO₄), lithium nitrate (LiNO₃), lithium acetate (CH₃COOLi), lithium oxalate (Li₂C₂O₄), lithium carbonate (Li₂CO₃), lithium bis(trifluoromethanesulfonyl)imide (LiTFSI: LiN(SO₂CF₃)₂), lithium bis(fluorosulfonyl)imide (LiFSI: LiN(SO₂F)₂), lithium bis(oxalate)borate (LiBOB: LiB[(OCO)₂]₂), or the like can be used.

As the sodium salt, for example, sodium chloride (NaCl), sodium sulfate (Na₂SO₄), sodium hydroxide (NaOH), sodium nitrate (NaNO₃), sodium trifluoromethanesulfonyl amide (NaTFSA), or the like can be used.

(4) Aqueous Electrolyte

The aqueous electrolyte contains an aqueous solvent and an electrolyte salt. The aqueous electrolyte is in the form of liquid, for example. The liquid aqueous electrolyte is an aqueous solution prepared by dissolving an electrolyte salt as a solute in the aqueous solvent. The aqueous solution contains, preferably, 1 mol or more, and more preferably, 3.5 mol or more, of an aqueous solvent per 1 mol of the salt as a solute.

The aqueous solvent employable is a water-containing solution. The water-containing solution may be pure water, or may be a mixed solvent of water and an organic solvent. The aqueous solvent contains water, for example, at a ratio of 50% by volume or more.

Inclusion of water in the aqueous electrolyte can be confirmed by GC-MS (gas chromatography-mass spectrometry) measurement. In addition, a salt concentration and a water content in the aqueous electrolyte can be measured, for example, by inductively coupled plasma (ICP) emission spectrometry. A molar concentration (mol/L) can be calculated by weighing a specified amount of the aqueous electrolyte, and by calculating the concentration of the salt contained therein. Further, the numbers of moles of the solute and solvent can be calculated by measuring the specific gravity of the aqueous electrolyte.

The aqueous electrolyte may be a gel-type electrolyte. The gel-type electrolyte is prepared by mixing and compounding the aforementioned liquid aqueous electrolyte and a polymer compound. Examples of the polymer compound include polyvinylidene fluoride (PVdF), polyacrylonitrile (PAN), and polyethylene oxide (PEO).

As the electrolyte salt, for example, a lithium salt, a sodium salt, or a mixture thereof can be used. As the lithium salt or sodium salt, the same salt that can be contained in the solid electrolyte layer can be used. As the lithium salt, LiCl is preferably contained. When LiCl is used, the lithium ion concentration of the aqueous electrolyte can be made high. Additionally, the lithium salt preferably contains at least one of LiSO₄ and LiOH in addition to LiCl.

The molar concentration of lithium ions in the aqueous electrolyte may be 3 mol/L or more, may be 6 mol/L or more, or may be 12 mol/L or more. According to one example, the molar concentration of lithium ions in the aqueous electrolyte is 14 mol/L or less. When the concentration of lithium ions in the aqueous electrolyte is high, electrolysis of the aqueous solvent at the negative electrode is more likely to be suppressed, and thereby generation of hydrogen from the negative electrode tends to decrease.

The aqueous electrolyte preferably contains, as an anion species, at least one anion species selected from the group consisting of a chloride ion (Cl⁻), a hydroxide ion (OH⁻), a sulphate ion (SO₄²⁻), and a nitrate ion (NO₃⁻).

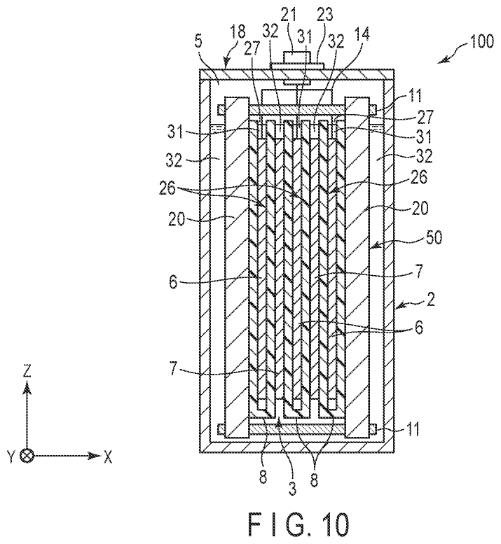

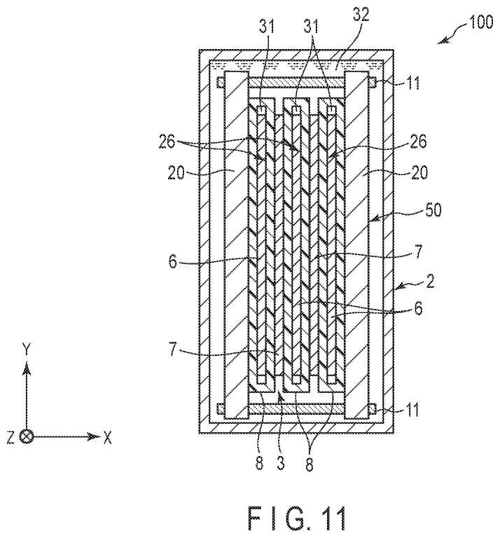

The pH of the aqueous electrolyte is, preferably, 3 or more and 14 or less, and more preferably, 4 or more and 13 or less. As will be described later with reference to FIG. 10 and FIG. 11, when different electrolytes are used for the negative electrode-side electrolyte and the positive electrode-side electrolyte, the pH of the negative electrode-side electrolyte is, preferably, in a range of 3 or more to 14 or less, and the pH of the positive electrode-side electrolyte is, preferably, in a range of 1 or more to 8 or less.

With the pH of the negative electrode-side electrolyte being in the above-described range, the hydrogen generation potential at the negative electrode lowers, and thus the hydrogen generation at the negative electrode is suppressed. Thereby, the storage performance and cycle life performance of the battery are improved. With the pH of the positive electrode-side electrolyte being in the above-described range, the oxygen generation potential at the positive electrode increases, and thus the oxygen generation at the positive electrode decreases. Thereby, the storage performance and cycle life performance of the battery are improved. The pH of the positive electrode-side electrolyte is, for preferably, in a range of 3 or more to 7.5 or less.

The aqueous electrolyte may include a surface-active agent. Examples of the surface-active agent include polyoxyalkylene alkyl ether, polyethylene glycol, polyvinyl alcohol, thiourea, 3,3′-dithiobis(1-propanephosphinic acid)disodium, dimercaptothiadiazole, boric acid, oxalic acid, malonic acid, saccharine, sodium naphthalene sulfonate, gelatin, potassium nitrate, aromatic aldehyde, and heterocyclic aldehyde. The surface-active agent can be used singly, or two or more kinds of surface-active agents can be mixed and used.

(5) Container Member

As the container member that stores the electrode structure and the aqueous electrolyte, a metal container, a laminated film container, or a resin container can be used.

As the metal container, a metal can made of nickel, iron, stainless steel, or the like and having a rectangular shape or a cylindrical shape can be used. As the resin container, a container made of polyethylene, polypropylene, or the like can be used.

The board thickness of each of the resin container and the metal container preferably falls within the range of 0.05 mm to 1 mm. The board thickness is more preferably 0.5 mm or less, and much more preferably 0.3 mm or less.

As the laminated film, for example, a multilayered film formed by covering a metal layer with a resin layer can be used. Examples of the metal layer include a stainless steel foil, an aluminum foil, and an aluminum alloy foil. As the resin layer, a polymer such as polypropylene (PP), polyethylene (PE), nylon, or polyethylene terephthalate (PET) can be used. The thickness of the laminated film preferably falls within the range of 0.01 mm to 0.5 mm. The thickness of the laminated film is more preferably 0.2 mm or less.

(6) Negative Electrode Terminal

The negative electrode terminal can be formed of a material which is electrochemically stable at the Li insertion/extraction potential of the above negative electrode active material and has conductivity. Specific examples of the material of the negative electrode terminal include zinc, copper, nickel, stainless steel and aluminum, and aluminum alloy containing at least one element selected from the group consisting of Mg, Ti, Zn, Mn, Fe, Cu, and Si. The negative electrode terminal is preferably formed of the same material as that of the negative electrode current collector in order to reduce the contact resistance with the negative electrode current collector.

(7) Positive Electrode Terminal

The positive electrode terminal can be formed of a material which is electrically stable in a potential range (vs. Li/Li⁺) where the potential with respect to an oxidation-reduction potential of lithium is from 2.5 V to 5.5 V and has conductivity. Examples of the material of the positive electrode terminal include aluminum and aluminum alloy containing at least one element selected from the group consisting of Mg, Ti, Zn, Mn, Fe, Cu, and Si. The positive electrode terminal is preferably formed of the same material as that of the positive electrode current collector in order to reduce the contact resistance with the positive electrode current collector.

(8) Form of Secondary Battery

The secondary battery according to the embodiment can be used in various forms such as a rectangular shape, a cylindrical shape, a flat type, a thin type, and a coin type. In addition, the secondary battery may be a secondary battery having a bipolar structure. The secondary battery having a bipolar structure is advantageous in producing a plurality of serial cells by one cell.

The secondary battery according to the embodiment will be described in more detail with reference to the drawings.

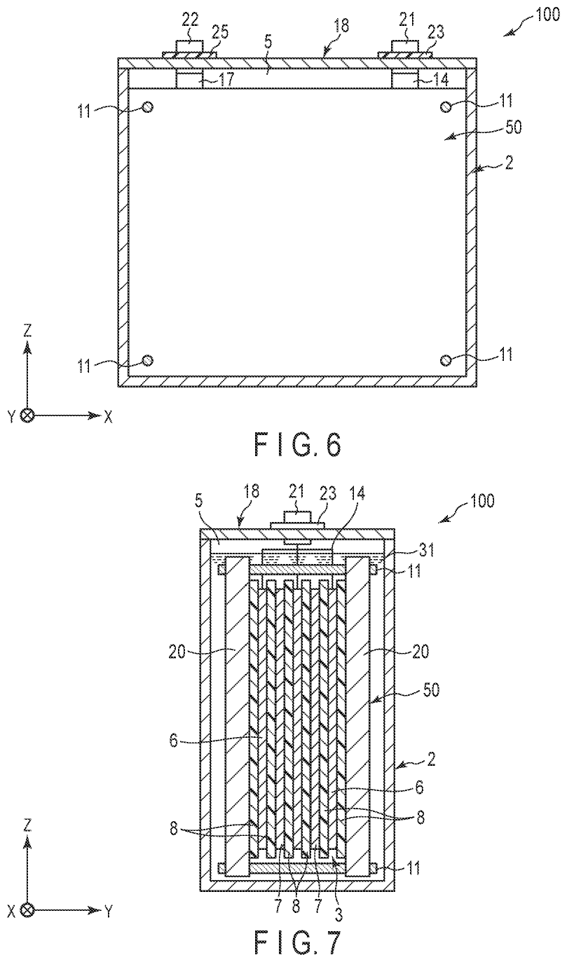

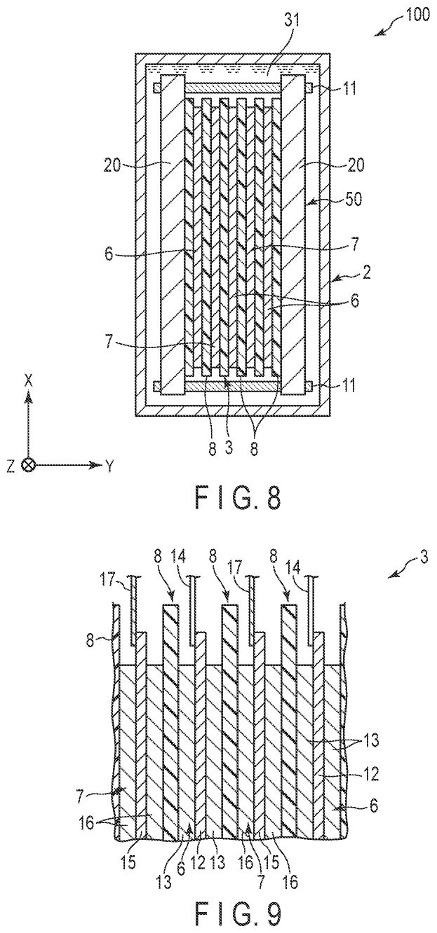

FIG. 6 to FIG. 9 illustrate an example of the secondary battery according to the embodiment. FIG. 6 illustrates a cross section of the secondary battery in a direction perpendicular or substantially perpendicular to the Y-axis direction. FIG. 7 illustrates a cross section perpendicular or substantially perpendicular to the X-axis direction. FIG. 8 illustrates a cross section perpendicular or substantially perpendicular to the Z-axis direction. In the present embodiment, the container member 2 has a bottomed cylindrical shape, and a storage space 5 of the container member 2 is open toward one side with respect to the Z-axis direction of the secondary battery 100.

The electrode structure 50 and an electrolyte 31 are stored in the storage space 5. The electrolyte 31 is, for example, an aqueous electrolyte. The electrode structure 50 shown in FIG. 6 to FIG. 9 has the same configuration as the electrode structure described with reference to FIG. 1 and FIG. 2, except that the number of positive electrodes 7 included in the electrode group 3, the number of negative electrodes 6 included in the electrode group 3 and the number of separators 8 included in the electrode group are all plural. In other words, the electrode group 3 shown in FIG. 6 to FIG. 9 includes a plurality of positive electrodes 7, a plurality of negative electrodes 6 and a plurality of separators 8. The electrode group may include one positive electrode, one negative electrode and one separator. In the electrode group 3, the negative electrodes 6 and positive electrodes 7 are alternately arranged, with the separators 8 being interposed therebetween. The direction in which the negative electrodes 6, positive electrodes 7 and separators 8 are stacked is the thickness direction of the electrode group 3. The hold members 20 clamp the electrode group 3 in the thickness direction of the electrode group 3.

FIG. 9 illustrates a part of the electrode group 3 in enlarged scale. In FIG. 9, the electrode group 3 is shown by a cross section perpendicular or substantially perpendicular to the X-axis direction. As illustrated in FIG. 9 and the like, each of the negative electrodes 6 includes a negative electrode current collector 12 and a negative electrode active material-containing layer 13. The negative electrode active material-containing layer 13 contains a negative electrode active material, and is supported on both surfaces or one surface of the negative electrode current collector 12. In addition, the negative electrode current collector 12 includes a portion (negative electrode current-collecting tab portion) on which the negative electrode active material-containing layer 13 is not supported. Similarly, each of the positive electrodes 7 includes a positive electrode current collector 15 and a positive electrode active material-containing layer 16. The positive electrode active material-containing layer 16 contains a positive electrode active material, and is supported on both surfaces or one surface of the positive electrode current collector 15. In addition, the positive electrode current collector 15 includes a portion (positive electrode current-collecting tab portion) on which the positive electrode active material-containing layer 16 is not supported.

According to one example, the negative electrodes 6 are disposed at both outer ends in the thickness direction of the electrode group 3. As regards the negative electrode current collector 12 of each of the negative electrodes 6 disposed at both outer ends, the negative electrode active material-containing layer 13 is supported on only one surface of the negative electrode current collector 12, i.e., only the surface facing the inside in the thickness direction. As regards each of the negative electrodes 6 other than the negative electrodes 6 disposed at both outer ends, the negative electrode active material-containing layers 13 are supported on both surfaces of the negative electrode current collector 12. In addition, as regards each of all the positive electrodes 7, the positive electrode active material-containing layers 16 are supported on both surfaces of the positive electrode current collector 15.

As illustrated in FIG. 6, FIG. 7 and FIG. 9, the secondary battery 100 includes a negative electrode lead 14, a positive electrode lead 17 and a cover 18. The cover 18 is formed of, for example, a metal. The cover 18 is attached to the container member 2 by welding or the like at the opening portion of the storage space 5, thereby closing the opening portion of the storage space 5. Each of the leads 14 and 17 is formed of, for example, a metal or the like, and has electrical conductivity. In each of the negative electrodes 6, in the negative electrode current collector 12, the negative electrode lead 14 is connected to the negative electrode current-collecting tab portion on which the negative electrode active material-containing layer 13 is not supported. Similarly, in each of the positive electrodes 7, in the positive electrode current collector 15, the positive electrode lead 17 is connected to the positive electrode current-collecting tab portion on which the positive electrode active material-containing layer 16 is not supported. The leads 14 and 17 are disposed, spaced apart from each other in the X-axis direction, thus preventing a mutual contact between the leads 14 and 17. In addition, the contact of each of the leads 14 and 17 with the container member 2 and cover 18 is prevented by an insulating member (not shown) or the like. Thus, short-circuit between the leads 14 and 17 is effectively prevented.

A negative electrode terminal 21 and a positive electrode terminal 22 are attached to an outer surface of the cover 18. Each of the terminals 21 and 22 is formed of, for example, a metal or the like, and has electrical conductivity. The negative electrode lead 14 is connected to the negative electrode terminal 21, and the positive electrode lead 17 is connected to the positive electrode terminal 22. The terminals 21 and 22 are disposed, spaced part from each other in the X-axis direction, and a mutual contact between the terminals 21 and 22 is prevented. In addition, the contact of the negative electrode terminal 21 with the cover 18 is prevented by an insulating member 23 or the like, and the contact of the positive electrode terminal 22 with the cover 18 is prevented by an insulating member 25 or the like. Thus, short-circuit between the terminals 21 and 22 is effectively prevented.

FIG. 10 and FIG. 11 schematically illustrate another example of the secondary battery according to the embodiment. A secondary battery 100 relating to FIG. 10 and FIG. 11 has the same configuration as the secondary battery 100 described with reference to FIG. 6 to FIG. 9, except that the separators 8, which the electrode group 3 includes, include one or more bags 26. In the secondary battery 100 relating to FIG. 10 and FIG. 11, all the separators 8 include bags 26, but the number of separators 8, which include bags 26, may be one.

The number of separators 8, which include bags 26, is, for example, equal to the number of negative electrodes 6. One of the plural negative electrodes 6 is stored in each of the bags 26. Each of the gas 26 is disposed in the storage space 5 of the container member 2 in a state in which each of the bag 26 includes one of the negative electrodes 6. Each of the bags 26 has a bag opening 27. In the bag opening 27, the inside of each bag 26 is open toward the side on which the cover 18 is located, in the Z-axis direction of the secondary battery 100. Each of the bags 26 is open to the outside in only the bag opening 27, and is not open to the outside in parts other than the bag opening 27. In other words, each of the bags 26 is closed in parts other than the bag opening 27.

In the storage space 5 of the container member 2, each of the positive electrodes 7 is disposed on the outside of all the bags 26, and is not stored in any of the bags 26. In the present embodiment, as described above, the negative electrodes 6 and the positive electrodes 7 are alternately arranged. Accordingly, in the storage space 5, the bags 26 and the positive electrodes 7 are alternately arranged in the state in which one of the negative electrodes 6 is stored in each of the bags 26. At least a part of the separator 8 (bag 26) is interposed between the mutually neighboring negative electrode 6 and positive electrode 7.

FIG. 10 and FIG. 11 illustrate the case in which the negative electrodes 6 are stored in the bags 26, respectively, and the positive electrodes 7 are disposed outside the bags 26. However, the positive electrodes 7 may be stored in the bags 26, respectively, and the negative electrodes 6 may be disposed outside the bags 26. In addition, when one negative electrode 6 and one positively electrode 7 are included in the electrode group 3, the number of bags 26 may be one. In this case, the number of negative electrodes 6 or positive electrodes 7 stored in the bags 26 may be one.

As illustrated in FIG. 10 and FIG. 11, the secondary battery 100 includes a first electrolyte 31 and a second electrolyte 32. According to one example, each of the first electrolyte 31 and second electrolyte 32 is an aqueous electrolyte including an aqueous solvent. The first electrolyte 31 is contained in the inside of each of the bags 26. The first electrolyte 31 contained in the inside of the bags 26 is held (impregnated) in the negative electrode 6 stored in the bag 26. In addition, the second electrolyte 32 is contained outside all the bags 26 in the storage space 5. In addition, on the outside of all bags 26 in the storage space 5, the second electrolyte 32 is held (impregnated) in the positive electrode 7.

Accordingly, in the present embodiment, the first electrolyte (negative electrode-side electrolyte) 31 and second electrolyte (positive electrode-side electrolyte) 32 are used. The first electrolyte 31 and second electrolyte 32 are isolated from each other by the bags 26 of the separators 8. Since the electrode disposed in the inside of the bag 26 is the negative electrode, the first electrolyte 31 contained in each bag 26 is the negative electrode-side electrolyte, and the second electrolyte 32 disposed on the outside of all the bags 26 is the positive electrode-side electrolyte.

In the secondary battery 100, the liquid surface or interface, which each of the first electrolyte 31 and second electrolyte 32 has, is kept on the side opposite to the side where the cover 18 is located, with respect to the bag opening 27 of each bag 2, i.e., at a vertically lower-side position in the Z-axis direction. Thereby, the outflow of the electrolyte 31 to the outside of the bag 26 through the bag opening 27 is effectively prevented, and the inflow of the electrolyte 32 into the bag 26 through the bag opening 27 is effectively prevented.

According to the secondary battery 100 illustrated in FIG. 10 and FIG. 11, the first electrolyte 31 and second electrolyte 32, which have mutually different properties, can be used. For example, the first electrolyte 31 and second electrolyte 32 may have mutually different pHs, may have mutually different osmotic pressures, and may have mutually different viscosities. In addition, for example, at least one of the first electrolyte 31 and second electrolyte 32 may be a liquid-type aqueous electrolyte. When one of the first electrolyte 31 and second electrolyte 32 is a liquid-type aqueous electrolyte, the other may be a gel-type aqueous electrolyte.

The secondary battery according to the embodiment may constitute a battery module. The battery module includes a plurality of the secondary batteries according to the embodiment. In the battery module, the unit cells may be arranged by being electrically connected in series or in parallel, or may be arranged by being electrically connected in series and in parallel in a combined manner.

According to the second embodiment, a secondary battery is provided. The secondary battery includes the electrode structure according to the first embodiment. Therefore, the secondary battery exhibits an excellent charge-and-discharge efficiency.

### Third Embodiment

According to the third embodiment, a battery pack is provided. The battery pack includes the secondary battery according to the second embodiment. The battery pack may include the secondary battery according to the third embodiment or may include a battery module constituted of a plurality of the secondary batteries.

The battery pack according to the third embodiment may further include a protective circuit. The protective circuit has a function to control charging and discharging of the secondary battery. Alternatively, a circuit included in equipment where the battery pack serves as a power source (for example, electronic devices, vehicles, and the like) may be used as the protective circuit for the battery pack.

Moreover, the battery pack according to the third embodiment may further comprise an external power distribution terminal. The external power distribution terminal is configured to externally output current from the secondary battery, and to input external current into the secondary battery. In other words, when the battery pack is used as a power source, the current is provided out via the external power distribution terminal. When the battery pack is charged, the charging current (including regenerative energy of motive force of vehicles such as automobiles) is provided to the battery pack via the external power distribution terminal.

Next, an example of a battery pack according to the third embodiment will be described with reference to the drawings.

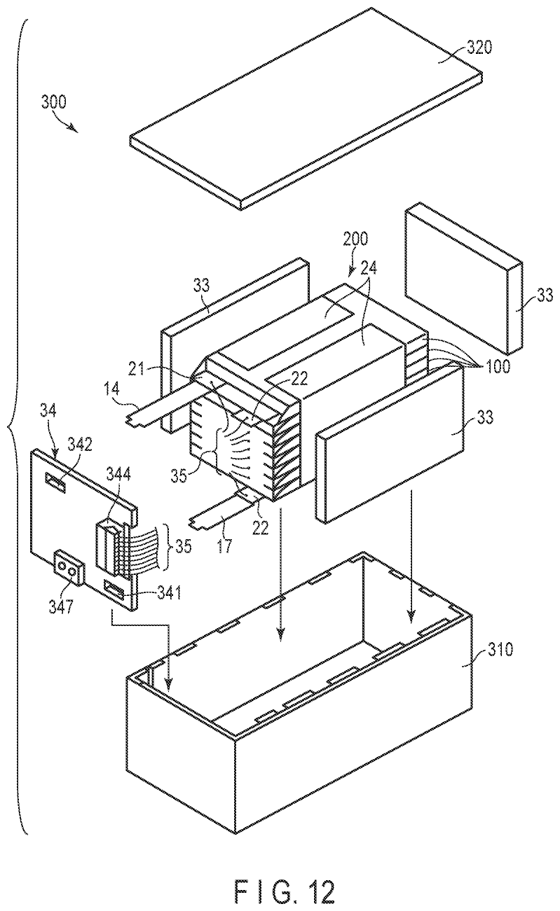

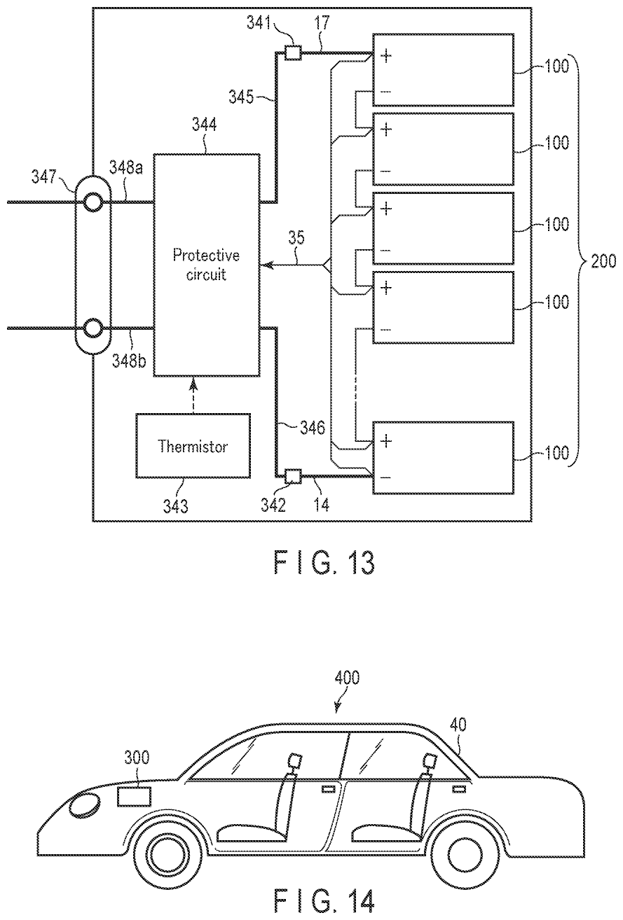

FIG. 12 is an exploded perspective view schematically showing an example of the battery pack according to the third embodiment. FIG. 13 is a block diagram showing an example of an electric circuit of the battery pack shown in FIG. 12.

A battery pack 300 shown in FIGS. 12 and 13 includes a housing container 310, a lid 320, protective sheets 33, a battery module 200, a printed wiring board 34, wires 35, and an insulating plate (not shown).

The housing container 310 shown in FIG. 12 is a square bottomed container having a rectangular bottom surface. The housing container 310 is configured to be capable of storing the protective sheets 33, the battery module 200, the printed wiring board 34, and the wires 35. The lid 320 has a rectangular shape. The lid 320 covers the housing container 310 to store the battery module 200 and so on. The housing container 310 and the lid 320 are provided with openings, connection terminals, or the like (not shown) for connection to an external device or the like.

The battery module 200 includes plural single-batteries 100, a positive electrode lead 17, a negative electrode lead 14, and an adhesive tape 24.

At least one of the plural single-batteries 100 is a secondary battery according to the second embodiment. The plural single-batteries 100 are stacked such that the negative electrode terminals 21 and the positive electrode terminals 22, which extend outside, are directed toward the same direction. The plural single-batteries 100 are electrically connected in series, as shown in FIG. 13. The plural single-batteries 100 may alternatively be electrically connected in parallel, or connected in a combination of in-series connection and in-parallel connection. If the plural single-batteries 100 are connected in parallel, the battery capacity increases as compared to a case in which they are connected in series.

The adhesive tape 24 fastens the plural single-batteries 100. The plural single-batteries 100 may be fixed using a heat-shrinkable tape in place of the adhesive tape 24. In this case, the protective sheets 33 are arranged on both side surfaces of the battery module 200, and the heat-shrinkable tape is wound around the battery module 200 and protective sheets 33. After that, the heat-shrinkable tape is shrunk by heating to bundle the plural single-batteries 100.

One end of the positive electrode lead 17 is connected to the positive electrode terminal 22 of the single-battery 100 located lowermost in the stack of the single-batteries 100. One end of the negative electrode lead 14 is connected to the negative electrode terminal 21 of the single-battery 100 located uppermost in the stack of the single-batteries 100.

A printed wiring board 34 is disposed on the one inner surface along the short-side direction of inner surfaces of the housing container 310. The printed wiring board 34 includes a positive electrode-side connector 341, a negative electrode-side connector 342, a thermistor 343, a protective circuit 344, wirings 345 and 346, an external power distribution terminal 347, a plus-side (positive-side) wire 348a, and a minus-side (negative-side) wire 348b. One main surface of the printed wiring board 34 faces the surface of the battery module 200 from which the negative electrode terminals 21 and the positive electrode terminals 22 extend out. An insulating plate (not shown) is disposed in between the printed wiring board 34 and the battery module 200.

The positive electrode-side connector 341 is provided with a through-hole. By inserting the other end of the positive electrode lead 17 into the though-hole, the positive electrode-side connector 341 and the positive electrode lead 17 become electrically connected. The negative electrode-side connector 342 is provided with a through-hole. By inserting the other end of the negative electrode lead 14 into the though-hole, the negative electrode-side connector 342 and the negative electrode lead 14 become electrically connected.

The thermistor 343 is fixed to one main surface of the printed wiring board 34. The thermistor 343 detects the temperature of each single-battery 100 and transmits detection signals to the protective circuit 344.

The external power distribution terminal 347 is fixed to the other main surface of the printed wiring board 34. The external power distribution terminal 347 is electrically connected to device(s) that exists outside the battery pack 300.

The protective circuit 344 is fixed to the other main surface of the printed wiring board 34. The protective circuit 344 is connected to the external power distribution terminal 347 via the plus-side wire 348a. The protective circuit 344 is connected to the external power distribution terminal 347 via the minus-side wire 348b. In addition, the protective circuit 344 is electrically connected to the positive electrode-side connector 341 via the wiring 345. The protective circuit 344 is electrically connected to the negative electrode-side connector 342 via the wiring 346. Furthermore, the protective circuit 344 is electrically connected to each of the plural single-batteries 100 via the wires 35.

The protective sheets 33 are arranged on both inner surfaces of the housing container 310 along the long-side direction and on the inner surface along the short-side direction, facing the printed wiring board 34 across the battery module 200 positioned therebetween. The protective sheets 33 are made of, for example, resin or rubber.

The protective circuit 344 controls charge and discharge of the plural single-batteries 100. The protective circuit 344 is also configured to cut-off electric connection between the protective circuit 344 and the external power distribution terminal 347 to external devices, based on detection signals transmitted from the thermistor 343 or detection signals transmitted from each single-battery 100 or the battery module 200.

An example of the detection signal transmitted from the thermistor 343 is a signal indicating that the temperature of the single-battery (single-batteries) 100 is detected to be a predetermined temperature or more. An example of the detection signal transmitted from each single-battery 100 or the battery module 200 is a signal indicating detection of over-charge, over-discharge, and overcurrent of the single-battery (single-batteries) 100. When detecting over-charge or the like for each of the single batteries 100, the battery voltage may be detected, or a positive electrode potential or negative electrode potential may be detected. In the latter case, a lithium electrode to be used as a reference electrode may be inserted into each single battery 100.

Note that, as the protective circuit 344, a circuit included in a device (for example, an electronic device or an automobile) that uses the battery pack 300 as a power source may be used.

As described above, the battery pack 300 includes the external power distribution terminal 347. Hence, the battery pack 300 can output current from the battery module 200 to an external device and input current from an external device to the battery module 200 via the external power distribution terminal 347. In other words, when using the battery pack 300 as a power source, the current from the battery module 200 is supplied to an external device via the external power distribution terminal 347. When charging the battery pack 300, a charge current from an external device is supplied to the battery pack 300 via the external power distribution terminal 347. If the battery pack 300 is used as an onboard battery, the regenerative energy of the motive force of a vehicle can be used as the charge current from the external device.

Note that the battery pack 300 may include plural battery modules 200. In this case, the plural battery modules 200 may be connected in series, in parallel, or connected in a combination of in-series connection and in-parallel connection. The printed wiring board 34 and the wires 35 may be omitted. In this case, the positive electrode lead 17 and the negative electrode lead 14 may be used as the external power distribution terminal.

Such a battery pack is used, for example, in applications where excellent cycle performance is demanded when a large current is extracted. More specifically, the battery pack is used as, for example, a power source for electronic devices, a stationary battery, or an onboard battery for vehicles. An example of the electronic device is a digital camera. The battery pack is particularly favorably used as an onboard battery.

A battery pack according to the third embodiment includes the secondary battery according to the secondary battery. Accordingly, the battery pack relating to the third embodiment has an excellent charge-and-discharge efficiency.

### Fourth Embodiment

According to the fourth embodiment, a vehicle is provided. The vehicle includes the battery pack according to the third embodiment.

In the vehicle according to the fourth embodiment, the battery pack is configured to collect regenerative energy of the power of the vehicle. The vehicle can include a mechanism (regenerator) configured to convert kinetic energy of the vehicle into regenerative energy.

Examples of the vehicle include two- to four-wheeled hybrid electric automobiles, two- to four-wheeled electric automobiles, electric assist bicycles, and railway cars.

In the vehicle, the installing position of the battery pack is not particularly limited. For example, the battery pack may be installed in the engine compartment of the vehicle, in rear parts of the vehicle, or under seats.

The vehicle may be equipped with a plurality of battery packs. In this case, the battery packs may be electrically connected in series, may be electrically connected in parallel, or may be electrically connected in a combination of series connection and parallel connection.

An example of the vehicle according to the fourth embodiment is explained below, with reference to the drawings.

FIG. 14 is a cross-sectional view schematically showing an example of a vehicle according to the fourth embodiment.

A vehicle 400, shown in FIG. 14 includes a vehicle body 40 and a battery pack 300 according to the third embodiment. In FIG. 14, the vehicle 400 is a four-wheeled automobile.

The vehicle 400 may have plural battery packs 300 installed. In such a case, the battery packs 300 may be connected in series, connected in parallel, or connected in a combination of in-series connection and in-parallel connection.

An example is shown in FIG. 14, where the battery pack 300 is installed in an engine compartment located at the front of the vehicle body 40. As described above, the battery pack 300 may be installed, for example, in rear sections of the vehicle body 40, or under a seat. The battery pack 300 may be used as a power source of the vehicle 400. The battery pack 300 can also recover regenerative energy of power of the vehicle 400.

In the vehicle according to the fourth embodiment, the battery pack according to the third embodiment is mounted. Therefore, according to the present embodiment, there can be provided the vehicle including the battery pack with an excellent charge-and-discharge efficiency.

### Fifth Embodiment

According to the fifth embodiment, a stationary power supply is provided. The stationary power supply is mounted with the battery pack according to the third embodiment. Note that instead of the battery pack according to the third embodiment, the stationary power supply may have the secondary battery or the battery module according to the second embodiment.

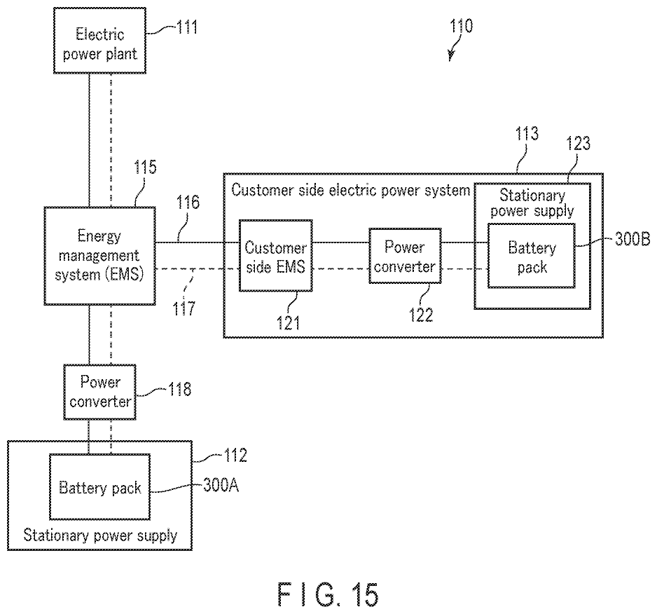

FIG. 15 is a block diagram showing an example of a system including a stationary power supply according to the fifth embodiment. FIG. 15 is a diagram showing an application example to stationary power supplies 112, 123 as an example of use of battery packs 300A, 300B according to the third embodiment. In the example shown in FIG. 15, a system 110 in which the stationary power supplies 112, 123 are used is shown. The system 110 includes an electric power plant 111, the stationary power supply 112, a customer side electric power system 113, and an energy management system (EMS) 115. Also, an electric power network 116 and a communication network 117 are formed in the system 110, and the electric power plant 111, the stationary power supply 112, the customer side electric power system 113 and the EMS 115 are connected via the electric power network 116 and the communication network 117. The EMS 115 performs control to stabilize the entire system 110 by utilizing the electric power network 116 and the communication network 117.

The electric power plant 111 generates a large amount of electric power from fuel sources such as thermal power or nuclear power. Electric power is supplied from the electric power plant 111 through the electric power network 116 and the like. In addition, the battery pack 300A is installed in the stationary power supply 112. The battery pack 300A can store electric power and the like supplied from the electric power plant 111. In addition, the stationary power supply 112 can supply the electric power stored in the battery pack 300A through the electric power network 116 and the like. The system 110 is provided with an electric power converter 118. The electric power converter 118 includes a converter, an inverter, a transformer and the like. Thus, the electric power converter 118 can perform conversion between direct current (DC) and alternate current (AC), conversion between alternate currents of frequencies different from each other, voltage transformation (step-up and step-down) and the like. Therefore, the electric power converter 118 can convert electric power from the electric power plant 111 into electric power that can be stored in the battery pack 300A.

The customer side electric power system 113 includes an electric power system for factories, an electric power system for buildings, an electric power system for home use and the like. The customer side electric power system 113 includes a customer side EMS 121, an electric power converter 122, and the stationary power supply 123. The battery pack 300B is installed in the stationary power supply 123. The customer side EMS 121 performs control to stabilize the customer side electric power system 113.

Electric power from the electric power plant 111 and electric power from the battery pack 300A are supplied to the customer side electric power system 113 through the electric power network 116. The battery pack 300B can store electric power supplied to the customer side electric power system 113. Similarly to the electric power converter 118, the electric power converter 122 includes a converter, an inverter, a transformer and the like. Thus, the electric power converter 122 can perform conversion between direct current and alternate current, conversion between alternate currents of frequencies different from each other, voltage transformation (step-up and step-down) and the like. Therefore, the electric power converter 122 can convert electric power supplied to the customer side electric power system 113 into electric power that can be stored in the battery pack 300B.

Note that the electric power stored in the battery pack 300B can be used, for example, for charging a vehicle such as an electric vehicle. Also, the system 110 may be provided with a natural energy source. In such a case, the natural energy source generates electric power by natural energy such as wind power and solar light. In addition to the electric power plant 111, electric power is also supplied from the natural energy source through the electric power network 116.

The stationary power supply according to the fifth embodiment includes the battery pack according to the third embodiment. Therefore, according to the present embodiment, there can be provided the stationary power supply including the battery pack with an excellent charge-and-discharge efficiency.

### EXAMPLES

Examples will be described below. The Examples are not limited to the following ones.

### Example 1

A battery was manufactured in the procedure described below.

<Fabrication of Positive Electrode>

A positive electrode was fabricated as described below.

LiMn₂O₄ (5 g) serving as a positive electrode active material, acetylene black (0.25 g) serving as a conductive agent, and a PVDF dispersion liquid (an NMP solution with a solid content ratio of 8%; 6.25 g) serving as a conductive agent were mixed for three minutes by using a kneader, and a viscous slurry was obtained. The slurry was coated on one surface of a Ti foil. Thereafter, the solvent is distilled off at 120° C., and a multilayer body was obtained. Then, the multilayer body was rolled by using a roll press. After the obtained multilayer body was dried, the multilayer body was punched such that the dimensions, excluding the current-collecting tab portion, become 90 mm×80 mm. The weight per unit area of the obtained positive electrode was 200 g/m².

<Fabrication of Negative Electrode>

Li₄Ti₅O₁₂ (10 g) serving as a negative electrode active material, graphite (1 g) serving as a conductive agent, a PTFE dispersion liquid (a solid content ratio of 40%; 1 g) serving as a binder, and NMP (N-methyl-2-pyrrolidone) in an amount of 8 g were mixed for three minutes by using a kneader, and a slurry was obtained. The slurry was coated on one surface of a Zn foil. Thereafter, the solvent is distilled off at 120° C., and a multilayer body was obtained. Then, the multilayer body was rolled by using a roll press. After the obtained multilayer body was dried, the multilayer body was punched such that the dimensions, excluding the current-collecting tab portion, become 90 mm×80 mm. The weight per unit area of the obtained negative electrode was 100 g/m².

<Preparation of Aqueous Electrolyte>

An aqueous electrolyte, in which LiCl was dissolved in water at a concentration of 12 mol/L, was prepared.

<Manufacture of Electrode Structure>

Two flat plates made of stainless steel were prepared as hold members. The flat plate was a rectangular flat plate having dimensions with a longitudinal length of 108 mm, a transverse length of 96 mm, and a thickness of 10 mm. The flat plate had six through-holes in its peripheral parts. Of the six through-holes, four through-holes were provided at the four corners of the rectangular flat plate. Specifically, the four through-holes were provided at positions on diagonals on the major surface of the flat plate, each of the positions being at substantially equal distances from one side surface and from another side surface neighboring the one side surface. One of the other two through-holes was provided at a middle point between the two through-holes provided along one long side of the rectangular flat plate. In addition, the other of the other two through-holes was provided at a middle point between the two through-holes provided along the other long side that is opposite to the one long side.

The previously fabricated positive electrode, a separator, and the previously fabricated negative electrode were stacked in the named order, and a stacked electrode group having a thickness of 10 mm was manufactured. Note that, as the separator, use was made of a solid electrolyte compound film having lithium ion conductivity and including LATP (Li_{1.3}Al_{0.3}Tl_{1.7} (PO₄)₃) powder with a median size D50 of 1 μm, and PVB (Polyvinyl butyral) at a mass ratio of 9:1.

The manufactured electrode group was clamped in the thickness direction by the two hold members. A polytetrafluoroethylene (PTFE) sheet with a thickness of 0.05 mm was interposed as an insulative sheet between the electrode group and the hold member, thus securing insulation. Thereafter, a bolt serving as fixing members was passed through each of the through-holes that one hold member has, and was made to penetrate through each of the through-holes provided in the other hold member at the corresponding position. Then, a nut was fastened on a distal end of the bolt that penetrates, and the two hold members were fixed in the state in which the electrode group was clamped between the two hold members. Since the axial tension per one set of the bolt and nut was 3000 N, the total axial tension acting on the electrode group was 18000 N. Thus, the electrode structure including the electrode group and the hold members was manufactured.

<Manufacture of Secondary Battery>

A container member made of stainless steel and having a bottomed rectangular cylindrical shape was prepared, and the previously manufactured electrode structure was accommodated in the storage space of the container member. The wall thickness of the container member was 0.25 mm. In addition, the previously prepared aqueous electrolyte was poured into the storage space of the container member. Thereafter, the opening portion of the container member was closed by using a cover, and a secondary battery was manufactured. Note that, as described with reference to FIG. 6 and the like in connection with the secondary battery, the positive electrode lead and negative electrode lead, which are electrically connected to the current collectors included in the positive and negative electrodes, are exposed to the outside of the container member.

### Examples 2 to 9

Secondary batteries were manufactured by the same method as in Example 1, except that the material and dimensions of the hold members were changed as shown in Table 1. In Table 1, “PEEK” indicates poly ether ether ketone, “PPS” indicates polyphenylenesulfide, and “PP” indicates polyprophylene.

### Example 10

A secondary battery was manufactured by the same method as in Example 1, except that the electrode structure further includes two stain suppression members. Each of the strain suppression members was a stainless steel plate having dimensions shown in Table 2. The two strain suppression members were interposed between the electrode group 3 and the hold members, respectively. In addition, a PTFE sheet with a thickness of 0.05 mm was interposed as an insulative sheet between one strain suppression member and the electrode group 3 and between the other strain suppression member and the electrode group 3. Note that each of the strain suppression members had six through-holes at the same positions as in the hold members.

### Examples 11 to 16

Secondary batteries were manufactured by the same method as in Example 10, except that the material and dimensions of the hold members were changed as shown in Table 1, and the material, dimensions and shape of the strain suppression members were changed as shown in Table 2.

### Examples 17 to 19

Secondary batteries were manufactured by the same method as in Example 1, except that the material, dimensions and shape of the hold member were changed as shown in Table 1.

### Examples 20 to 26

Secondary batteries were manufactured by the same method as in Example 10, except that the material and dimensions of the hold member were changed as shown in Table 1, and the material, dimensions and shape of the strain suppression member were changed as shown in Table 2.

### Examples 27 to 29

Secondary batteries were manufactured by the same method as in Example 1, except that the dimensions of the hold member were changed as shown in Table 3.

### Examples 30 to 32

Secondary batteries were manufactured by the same method as in Example 10, except that the dimensions of the hold member were changed as shown in Table 3, and the material of the strain suppression member was changed as shown in Table 4.

### Examples 33 to 35

Secondary batteries were manufactured by the same method as in Example 1, except that the dimensions of the electrode group were changed as shown in Table 3 by changing the dimensions of the positive electrode and negative electrode.

### Examples 36 to 38

Secondary batteries were manufactured by the same method as in Example 13, except that the dimensions of the electrode group were changed as shown in Table 3 by changing the dimensions of the positive electrode and negative electrode, and that the material of the strain suppression member was changed as shown in Table 4.

### Examples 39 to 41

Secondary batteries were manufactured by the same method as in Example 2, except that the thickness of the electrode group was changed as shown in Table 3.

### Examples 41 to 44

Secondary batteries were manufactured by the same method as in Example 1, except that the thickness of the hold member was changed as shown in Table 3.

### Comparative Examples 1 to 3

In Comparative Examples 1 to 3, secondary batteries were manufactured by the same methods as in Examples 7 to 9, except that as the two hold members, hold members each having a thickness of 5 mm were used.

### Comparative Example 4

A secondary battery was manufactured by the same method as in Example 2, except that each bolt was fastened more strongly. The axial tension acting on the hold member by one bolt was 30000 N.

### Comparative Example 5

A secondary battery was manufactured by the same method as in Example 2, except that the number of through-holes provided in the peripheral parts of the hold member was increased to ten, that the number of bolts provided in the through-holes was increased to ten, and that the axial tension acting on the hold member by each bolt was changed to 5000 N.

### Comparative Examples 6 and 7

Secondary batteries were manufactured by the same method as in Example 2, except that the thickness of the hold member was changed as shown in Table 3.

<Measurement of m and L>

As regards the secondary batteries obtained in the respective Examples and the respective Comparative Examples, X-ray CT observation was conducted according to the method described in the first embodiment, and the displacement m and the maximum length L were measured. The results are shown in Table 2 and Table 4.

<Constant Current Charge-and-Discharge Test>

As regards the respective Examples and the respective Comparative Examples, after the secondary battery was manufactured, a constant current (CC) charge-and-discharge test was conducted. The test was conducted at a 1 C rate for both the charge and the discharge. In addition, at the time of the charge, as the condition for ending the charge, the earliest time was chosen from among a time until the current value reaches 0.5 C, a time until the charge time reaches 130 minutes, and a time until the charge capacity reaches 170 mAh/g. At the time of the discharge, the elapse of 130 minutes was set as the condition for ending the discharge. The execution of one-time charge and one-time discharge was set as one charge-and-discharge cycle, and the coulomb efficiency was calculated by a percentage according to a calculation formula below, from the charge capacity and discharge capacity in the 50th cycle. The coulomb efficiency is an index for evaluating the charge-and-discharge efficiency. The results of constant current charge-and-discharge tests are summarized in Table 2 and Table 4.

Coulomb efficiency (%)=100×(discharge capacity/charge capacity)

TABLE 1

| | Electrode group | | | Hold member | | | | | |
|---|---|---|---|---|---|---|---|---|---|
| | Longitudinal | Transverse | | | Longitudinal | Transverse | | Young's | |
| | dimension | dimension | Thickness | | dimension | dimension | Thickness | modulus | |
| | (mm) | (mm) | (mm) | Material | (mm) | (mm) | (mm) | (GPa) | Shape |
| Example 1 | 90 | 80 | 10 | Stainless steel | 108 | 96 | 10 | 200 | Flat |
| Example 2 | 90 | 80 | 10 | Stainless steel | 108 | 96 | 5 | 200 | Flat |
| Example 3 | 90 | 80 | 10 | Copper plate | 108 | 96 | 10 | 100 | Flat |
| Example 4 | 90 | 80 | 10 | Iron plate | 108 | 96 | 10 | 200 | Flat |
| Example 5 | 90 | 80 | 10 | Titanium plate | 108 | 96 | 10 | 100 | Flat |
| Example 6 | 90 | 80 | 10 | Nickel plate | 108 | 96 | 10 | 200 | Flat |
| Example 7 | 90 | 80 | 10 | PEEK | 108 | 96 | 30 | 0.3 | Flat |
| Example 8 | 90 | 80 | 10 | PPS | 108 | 96 | 30 | 0.4 | Flat |
| Example 9 | 90 | 80 | 10 | PP | 108 | 96 | 30 | 0.1 | Flat |
| Example 10 | 90 | 80 | 10 | PEEK | 108 | 96 | 30 | 0.3 | Flat |
| Example 11 | 90 | 80 | 10 | PEEK | 108 | 96 | 30 | 0.3 | Flat |
| Example 12 | 90 | 80 | 10 | PEEK | 108 | 96 | 30 | 0.3 | Flat |
| Example 13 | 90 | 80 | 10 | Stainless steel | 108 | 96 | 5 | 200 | Flat |
| Example 14 | 90 | 80 | 10 | Stainless steel | 108 | 96 | 5 | 200 | Flat |
| Example 15 | 90 | 80 | 10 | PEEK | 108 | 96 | 20 | 0.3 | Flat |
| Example 16 | 90 | 80 | 10 | PEEK | 108 | 96 | 20 | 0.3 | Flat |
| Example 17 | 90 | 80 | 10 | Stainless steel | 108 | 96 | 5 | 200 | Convex shape |
| | | | | | | | | | protruding |
| | | | | | | | | | toward electrode |
| Example 18 | 90 | 80 | 10 | Titanium plate | 108 | 96 | 5 | 100 | Convex shape |
| | | | | | | | | | protruding |
| | | | | | | | | | toward electrode |
| Example 19 | 90 | 80 | 10 | PEEK | 108 | 96 | 20 | 0.3 | Convex shape |
| | | | | | | | | | protruding |
| | | | | | | | | | toward electrode |
| Example 20 | 90 | 80 | 10 | Stainless steel | 108 | 96 | 5 | 200 | Flat |
| Example 21 | 90 | 80 | 10 | Stainless steel | 108 | 96 | 5 | 200 | Flat |
| Example 22 | 90 | 80 | 10 | Stainless steel | 108 | 96 | 5 | 200 | Flat |
| Example 23 | 90 | 80 | 10 | Stainless steel | 108 | 96 | 5 | 200 | Flat |
| Example 24 | 90 | 80 | 10 | PEEK | 108 | 96 | 20 | 0.3 | Flat |
| Example 25 | 90 | 80 | 10 | PEEK | 108 | 96 | 20 | 0.3 | Flat |
| Example 26 | 90 | 80 | 10 | PEEK | 108 | 96 | 20 | 0.3 | Flat |
| | | | | | | | Fixing members | | |
| | | | | | | | Axial tension | Number of | Total |
| | | | | | | | per one | fixing | axial |
| | | | | | | | fixing | members | tension |
| | | | | | | | members (N) | (Number) | (N) |
| | | | | | | Example 1 | 3000 | 6 | 18000 |
| | | | | | | Example 2 | 3000 | 6 | 18000 |
| | | | | | | Example 3 | 3000 | 6 | 18000 |
| | | | | | | Example 4 | 3000 | 6 | 18000 |
| | | | | | | Example 5 | 3000 | 6 | 18000 |
| | | | | | | Example 6 | 3000 | 6 | 18000 |
| | | | | | | Example 7 | 3000 | 6 | 18000 |
| | | | | | | Example 8 | 3000 | 6 | 18000 |
| | | | | | | Example 9 | 3000 | 6 | 18000 |
| | | | | | | Example 10 | 3000 | 6 | 18000 |
| | | | | | | Example 11 | 3000 | 6 | 18000 |
| | | | | | | Example 12 | 3000 | 6 | 18000 |
| | | | | | | Example 13 | 3000 | 6 | 18000 |
| | | | | | | Example 14 | 3000 | 6 | 18000 |
| | | | | | | Example 15 | 3000 | 6 | 18000 |
| | | | | | | Example 16 | 3000 | 6 | 18000 |
| | | | | | | Example 17 | 3000 | 6 | 18000 |
| | | | | | | Example 18 | 3000 | 6 | 18000 |
| | | | | | | Example 19 | 3000 | 6 | 18000 |
| | | | | | | Example 20 | 3000 | 6 | 18000 |
| | | | | | | Example 21 | 3000 | 6 | 18000 |
| | | | | | | Example 22 | 3000 | 6 | 18000 |
| | | | | | | Example 23 | 3000 | 6 | 18000 |
| | | | | | | Example 24 | 3000 | 6 | 18000 |
| | | | | | | Example 25 | 3000 | 6 | 18000 |
| | | | | | | Example 26 | 3000 | 6 | 18000 |

TABLE 2

| | Strain suppression member | | | | | | | | | Coulomb |
|---|---|---|---|---|---|---|---|---|---|---|
| | | Longitudinal | Transverse | Thick- | Young's | | Displace- | Maximum | | efficiency |
| | | dimension | dimension | ness | modulus | | ment | length | | (1C rate) |
| | Material | (mm) | (mm) | (mm) | (GPa) | Shape | m (μm) | L (mm) | m/L | [%] |
| Example 1 | — | — | — | — | — | — | 12 | 120 | 0.0001 | 97 |
| Example 2 | — | — | — | — | — | — | 60 | 120 | 0.0005 | 96 |
| Example 3 | — | — | — | — | — | — | 24 | 120 | 0.0002 | 96 |
| Example 4 | — | — | — | — | — | — | 12 | 120 | 0.0001 | 97 |
| Example 5 | — | — | — | — | — | — | 48 | 120 | 0.0004 | 96 |
| Example 6 | — | — | — | — | — | — | 12 | 120 | 0.0001 | 97 |
| Example 7 | — | — | — | — | — | — | 843 | 120 | 0.007 | 90 |
| Example 8 | — | — | — | — | — | — | 602 | 120 | 0.005 | 91 |
| Example 9 | — | — | — | — | — | — | 963 | 120 | 0.008 | 90 |
| Example 10 | Stainless steel | 108 96 | 5 | 200 | Flat | 6 | 120 | 0.00005 | 98 | |
| Example 11 | Titanium plate | 108 96 | 5 | 100 | Flat | 12 | 120 | 0.0001 | 97 | |
| Example 12 | PPS plate | 108 | 96 | 10 | 0.4 | Flat | 12 | 120 | 0.0001 | 97 |
| Example 13 | Stainless steel | 108 | 96 | 5 | 200 | Flat | 10 | 120 | 0.00008 | 98 |
| Example 14 | Stainless steel | 108 96 | 5 | 200 | Convex shape | 6 | 120 | 0.00005 | 98 | |
| | | | | | protruding | | | | | |
| | | | | | toward electrode | | | | | |
| Example 15 | PEEK | 108 96 | 10 | 0.3 | Flat | 60 | 120 | 0.0005 | 96 | |
| Example 16 | PEEK | 108 96 | 10 | 0.3 | Convex shape | 48 | 120 | 0.0004 | 96 | |
| | | | | | protruding | | | | | |
| | | | | | toward electrode | | | | | |
| Example 17 | — | — | — | — | — | — | 11 | 120 | 0.00009 | 98 |
| Example 18 | — | — | — | — | — | — | 12 | 120 | 0.0001 | 97 |
| Example 19 | — | — | — | — | — | — | 11 | 120 | 0.00009 | 98 |
| Example 20 | Titanium plate | 108 96 | 5 | 100 | Flat | 10 | 120 | 0.00008 | 98 | |
| Example 21 | Copper plate | 108 96 | 5 | 100 | Flat | 10 | 120 | 0.00008 | 98 | |
| Example 22 | PEEK | 108 | 96 | 10 | 0.3 | Flat | 11 | 120 | 0.00009 | 98 |
| Example 23 | PPS | 108 | 96 | 10 | 0.4 | Flat | 11 | 120 | 0.00009 | 98 |
| Example 24 | Stainless steel | 108 | 96 | 5 | 200 | Flat | 12 | 120 | 0.0001 | 97 |
| Example 25 | Titanium plate | 108 | 96 | 5 | 100 | Flat | 12 | 120 | 0.0001 | 97 |
| Example 26 | Copper plate | 108 | 96 | 5 | 100 | Flat | 12 | 120 | 0.0001 | 97 |

TABLE 3

| | Electrode group | | | Hold member | | | | | |
|---|---|---|---|---|---|---|---|---|---|
| | Longitudinal | Transverse | | | Longitudinal | Transverse | Young's | | |
| | dimension | dimension | Thickness | | dimension | dimension | Thickness | modulus | |
| | (mm) | (mm) | (mm) | Material | (mm) | (mm) | (mm) | (CPa) | Shape |
| Example 27 | 90 | 80 | 10 | Stainless steel | 200 | 250 | 10 | 200 | Flat |
| Example 28 | 90 | 80 | 10 | Stainless steel | 30 | 30 | 10 | 200 | Flat |
| Example 29 | 90 | 80 | 10 | Stainless steel | 1000 | 1500 | 10 | 200 | Flat |
| Example 30 | 90 | 80 | 10 | Stainless steel | 200 | 250 | 10 | 200 | Flat |
| Example 31 | 90 | 80 | 10 | Stainless steel | 30 | 30 | 10 | 200 | Flat |
| Example 32 | 90 | 80 | 10 | Stainless steel | 1000 | 1500 | 10 | 200 | Flat |
| Example 33 | 70 | 90 | 10 | Stainless steel | 108 | 96 | 10 | 200 | Flat |
| Example 34 | 50 | 60 | 10 | Stainless steel | 108 | 96 | 10 | 200 | Flat |
| Example 35 | 30 | 40 | 10 | Stainless steel | 108 | 96 | 10 | 200 | Flat |
| Example 36 | 70 | 90 | 10 | Stainless steel | 108 | 96 | 10 | 200 | Flat |
| Example 37 | 50 | 60 | 10 | Stainless steel | 108 | 96 | 10 | 200 | Flat |
| Example 38 | 30 | 40 | 10 | Stainless steel | 108 | 96 | 10 | 200 | Flat |
| Example 39 | 90 | 80 | 5 | Stainless steel | 108 | 96 | 5 | 200 | Flat |
| Example 40 | 90 | 80 | 100 | Stainless steel | 108 | 96 | 5 | 200 | Flat |
| Example 41 | 90 | 80 | 500 | Stainless steel | 108 | 96 | 5 | 200 | Flat |
| Example 42 | 90 | 80 | 10 | Stainless steel | 108 | 96 | 20 | 200 | Flat |
| Example 43 | 90 | 80 | 10 | Stainless steel | 108 | 96 | 30 | 200 | Flat |
| Example 44 | 90 | 80 | 10 | Stainless steel | 108 | 96 | 50 | 200 | Flat |
| Comparative | 90 | 80 | 100 | PEEK | 108 | 96 | 5 | 0.3 | Flat |
| Example 1 | | | | | | | | | |
| Comparative | 90 | 80 | 100 | PPS | 108 | 96 | 5 | 0.4 | Flat |
| Example 2 | | | | | | | | | |
| Comparative | 90 | 80 | 100 | PP | 108 | 96 | 5 | 0.1 | Flat |
| Example 3 | | | | | | | | | |
| Comparative | 90 | 80 | 100 | Stainless steel | 108 | 96 | 5 | 200 | Flat |
| Example 4 | | | | | | | | | |
| Comparative | 90 | 80 | 100 | Stainless steel | 108 | 96 | 5 | 200 | Flat |
| Example 5 | | | | | | | | | |
| Comparative | 90 | 80 | 100 | Stainless steel | 108 | 96 | 2 | 200 | Flat |
| Example 6 | | | | | | | | | |
| Comparative | 90 | 80 | 100 | Stainless steel | 108 | 96 | 1 | 200 | Flat |
| Example 7 | | | | | | | | | |
| | | | | | | | Fixing members | | |
| | | | | | | | Axial | | |
| | | | | | | | tension | Number | |
| | | | | | | | per one | of | Total |
| | | | | | | | fixing | fixing | axial |
| | | | | | | | members | members | tension |
| | | | | | | | (N) | (Number) | (N) |
| | | | | | | Example 27 | 3000 | 6 | 18000 |
| | | | | | | Example 28 | 3000 | 6 | 18000 |
| | | | | | | Example 29 | 3000 | 6 | 18000 |
| | | | | | | Example 30 | 3000 | 6 | 18000 |
| | | | | | | Example 31 | 3000 | 6 | 18000 |
| | | | | | | Example 32 | 3000 | 6 | 18000 |
| | | | | | | Example 33 | 3000 | 6 | 18000 |
| | | | | | | Example 34 | 3000 | 6 | 18000 |
| | | | | | | Example 35 | 3000 | 6 | 18000 |
| | | | | | | Example 36 | 3000 | 6 | 18000 |
| | | | | | | Example 37 | 3000 | 6 | 18000 |
| | | | | | | Example 38 | 3000 | 6 | 18000 |
| | | | | | | Example 39 | 3000 | 6 | 18000 |
| | | | | | | Example 40 | 3000 | 6 | 18000 |
| | | | | | | Example 41 | 3000 | 6 | 18000 |
| | | | | | | Example 42 | 3000 | 6 | 18000 |
| | | | | | | Example 43 | 3000 | 6 | 18000 |
| | | | | | | Example 44 | 3000 | 6 | 18000 |
| | | | | | | Comparative | 3000 | 6 | 18000 |
| | | | | | | Example 1 | | | |
| | | | | | | Comparative | 3000 | 6 | 18000 |
| | | | | | | Example 2 | | | |
| | | | | | | Comparative | 3000 | 6 | 18000 |
| | | | | | | Example 3 | | | |
| | | | | | | Comparative | 30000 | 6 | 180000 |
| | | | | | | Example 4 | | | |
| | | | | | | Comparative | 5000 | 10 | 50000 |
| | | | | | | Example 5 | | | |
| | | | | | | Comparative | 3000 | 6 | 18000 |
| | | | | | | Example 6 | | | |
| | | | | | | Comparative | 3000 | 6 | 18000 |
| | | | | | | Example 7 | | | |

TABLE 4

| | Strain suppression member | | | | | | Displace- | Maximum | | Coulomb |
|---|---|---|---|---|---|---|---|---|---|---|
| | | Longitudinal | Transverse | | Young's | | ment | length | | efficiency |
| | | dimension | dimension | Thickness | modulus | | m | L | | (1C rate) |
| | Material | (mm) | (mm) | (mm) | (GPa) | Shape | (μm) | (mm) | m/L | [%] |
| Example 27 | — | | | | | | 12 | 120 | 0.0001 | 97 |
| Example 28 | | | | | | | 10 | 120 | 0.00008 | 98 |
| Example 29 | | | | | | | 5 | 120 | 0.00004 | 98.5 |
| Example 30 | Titanium plate | 108 | 96 | 5 | 100 | Flat | 10 | 120 | 0.00008 | 98 |
| Example 31 | Titanium plate | 108 | 96 | 5 | 100 | Flat | 7 | 120 | 0.00006 | 98 |
| Example 32 | Titanium plate | 108 | 96 | 5 | 100 | Flat | 2 | 120 | 0.00002 | 98.5 |
| Example 33 | | | | | | | 23 | 114 | 0.0002 | 96 |
| Example 34 | | | | | | | 8 | 78 | 0.0001 | 97 |
| Example 35 | | | | | | | 5 | 50 | 0.00009 | 98 |
| Example 36 | Titanium plate | 108 | 96 | 5 | 100 | Flat | 10 | 114 | 0.00009 | 98 |
| Example 37 | Titanium plate | 108 | 96 | 5 | 100 | Flat | 7 | 78 | 0.00009 | 98 |
| Example 38 | Titanium plate | 108 | 96 | 5 | 100 | Flat | 4 | 50 | 0.00008 | 98 |
| Example 39 | | | | | | | 24 | 120 | 0.0002 | 96 |
| Example 40 | | | | | | | 84 | 120 | 0.0007 | 96 |
| Example 41 | | | | | | | 108 | 120 | 0.0009 | 95 |
| Example 42 | | | | | | | 5 | 120 | 0.00004 | 98.5 |
| Example 43 | | | | | | | 2 | 120 | 0.00002 | 98.5 |
| Example 44 | | | | | | | 1 | 120 | 0.00001 | 99 |
| Comparative | | | | | | | 12042 | 120 | 0.1 | 69 |
| Example 1 | | | | | | | | | | |
| Comparative | | | | | | | 10837 | 120 | 0.09 | 63 |
| Example 2 | | | | | | | | | | |
| Comparative | | | | | | | 14450 | 120 | 0.12 | 54 |
| Example 3 | | | | | | | | | | |
| Comparative | | | | | | | 6021 | 120 | 0.05 | 76 |
| Example 4 | | | | | | | | | | |
| Comparative | | | | | | | 4817 | 120 | 0.04 | 70 |
| Example 5 | | | | | | | | | | |
| Comparative | | | | | | | 7225 | 120 | 0.06 | 68 |
| Example 6 | | | | | | | | | | |
| Comparative | | | | | | | 14450 | 120 | 0.12 | 54 |
| Example 7 | | | | | | | | | | |

In Table 1 and Table 3, the column of “Fixing members” indicates the axial tension per one bolt (and nut) employed, the number of bolts included in the electrode structure according to each Example, and the total axial tension acting on the hold member. In Table 2 and Table 4, Examples, in which a sign “-” is indicated in the column of “Material” of “Strain suppression member”, do not include the “Strain suppression member”.

From Tables 1 to 4, the following is understood.

In Examples 1 to 44 in which the ratio m/L is 0.01 or less, excellent coulomb efficiencies were successfully achieved.

Although the electrode structures according to Examples 1 to 9, 17 to 19, 27 to 29, 33 to 35, and 39 to 44 did not include the strain suppression member, the m/L was 0.01 or less in each of these Examples. Among these Examples, in Examples in which a metallic plate with a high Young's modulus was used as the hold member, it is considered that the hold member was not easily bent even if a predetermined torque was applied to the peripheral part of the hold member. In addition, also in Examples in which a resin plate with a lower Young's modulus than the metallic plate was used, the ratio m/L was successfully lowered to 0.01 or less by using a hold plate with a predetermined thickness as the resin plate.

Besides, as regards the hold member employed, in Examples 17 to 19 in which that major surface of the hold member, which is opposed to the electrode group, has the arcuate shape (convex shape) protruding toward the electrode group side, the m/L could significantly be decreased even if the thickness of the hold member was relatively small.

Each of the electrode structures according to Examples 10 to 16, 20 to 26, 30 to 32, and 36 to 38 included two strain suppression members between the electrode group and the two hold members, and thus there was a tendency that a smaller m/L could be achieved. For instance, in Example 10, a flat plate formed of PEEK with a relatively low Young's modulus was used as the hold member, and a flat plate formed of stainless streel with a relatively high Young's modulus was used as the strain suppression member. In Example 10, it is considered that the bending of the hold member and strain suppression member could be suppressed by the strain suppression member. As a result, the m/L was as low as 0.00005. In addition, as shown in Examples 20 to 26, even when the material that constitutes the strain suppression member was variously changed, the m/L was successfully lowered to a small value.

As shown in Examples 27 to 44, also when the size and thickness of the electrode group, and the size and thickness of the hold member were changed, the coulomb efficiency in these Examples was excellent since the m/L was 0.01 or less.

In Comparative Examples 1 to 3, a flat plate formed of a resin with a much lower Young's modulus than stainless steel or the like was used as the hold member, and the thickness of the hold member was small. In addition, the electrode structures according to Comparative Examples 1 to 3 did not include the strain suppression member. Therefore, the m/L in these Comparative Examples exceeded 0.01, and the coulomb efficiency was poor.

In Comparative Examples 4 and 5, an excessively high fastening pressure was applied to the peripheral parts of the hold member. Thus, the end portions of the electrode group were crushed, and the m/L exceeded 0.01.

As shown in Comparative Examples 6 and 7, even when the fastening pressure on the hold member by the fixing members is the same as in the Examples, if the thickness of the hold member itself is not sufficient, there is a case in which the m/L exceeds 0.01. In this case, the coulomb efficiency lowers.

According to at least one of the above-described embodiments and Examples, an electrode structure is provided. The electrode structure includes an electrode group and a hold member. The hold member clamps the electrode group in a thickness direction of the electrode group. The electrode group satisfies a formula (1) below.

m/L≤0.01 (1)

Here, m is a difference Δt in a cross section which is selected from among a plurality of cross sections along the thickness direction of the electrode group such that the difference Δt becomes greatest, the difference Δt being a difference between a thickness t1 of a part T1 in which a thickness of the electrode group in the thickness direction is minimum and a thickness t2 of a part T2 in which the thickness of the electrode group in the thickness direction is maximum. L is a maximum length of the electrode group in an in-plane direction that is orthogonal to the thickness direction. According to the electrode structure, since the uniformity of the pressure acting within at least one surface of the electrode group is high, an excellent charge-and-discharge efficiency can be achieved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electrode structure comprising:
an electrode group; and
a hold member configured to clamp the electrode group in a thickness direction of the electrode group,
the electrode group satisfying a formula (1) below,
m/L≤0.01 (1)
wherein
the m is a difference Δt in a cross section which is selected from among a plurality of cross sections along the thickness direction of the electrode group such that the difference Δt becomes greatest, the difference Δt being a difference between a thickness t1 of a part T1 in which a thickness of the electrode group in the thickness direction is minimum and a thickness t2 of a part T2 in which the thickness of the electrode group in the thickness direction is maximum, and
the L is a maximum length of the electrode group in an in-plane direction that is orthogonal to the thickness direction.

2. The electrode structure according to claim 1, further comprising a strain suppression member interposed between the electrode group and the hold member.

3. The electrode structure according to claim 1, wherein
the electrode group has a first major surface opposed to the hold member, and a second major surface located on an opposite side to the first major surface, and
the electrode structure further comprises a first strain suppression member interposed between the first major surface of the electrode group and the hold member, and a second strain suppression member interposed between the second major surface of the electrode group and the hold member.

4. The electrode structure according to claim 1, further comprising:
a plurality of the hold members; and
fixing members which fixes the hold members to each other,
wherein the electrode group is clamped by one of the hold members and another of the hold members.

5. The electrode structure according to claim 1, wherein a ratio of the m to the thickness of the electrode group is in a range of 0% to 50%.

6. The electrode structure according to claim 1, wherein a Young's modulus of the hold member is 0.1 GPa or more.

7. The electrode structure according to claim 2, wherein a Young's modulus of the strain suppression member is 10 GPa or more.

8. A secondary battery comprising:
the electrode structure according to claim 1; and
an aqueous electrolyte,
wherein the electrode group comprises a positive electrode and a negative electrode.

9. A battery pack comprising the secondary battery according to claim 8.

10. The battery pack according to claim 9, further comprising:
an external power distribution terminal; and
a protective circuit.

11. The battery pack according to claim 9, comprising a plurality of the secondary battery, and the secondary batteries are electrically connected in series, or in parallel, or in series and in parallel in a combined manner.

12. A vehicle comprising the battery pack according to claim 9.

13. A stationary power supply comprising the battery pack according to claim 9.
